(19) United States
(12) Patent Application Publication
(10) Pub. No.: US 2026/0289248 A1
(43) Pub. Date: Sep. 24, 2026

(54) SYSTEM

(71) Applicant: SoftBank Group Corp., Tokyo (JP)

(72) Inventor: Hidetsune GOTO, Tokyo (JP)

(73) Assignee: SoftBank Group Corp., Tokyo (JP)

(21) Appl. No.: 19/568,914

(22) Filed: Mar. 17, 2026

(30) Foreign Application Priority Data
Mar. 19, 2025 (JP) 2025-045260

(51) Int. Cl. G06N 3/047; G06N 3/0475

(52) U.S. Cl. CPC G06N 3/047; G06N 3/0475

(57) ABSTRACT

A system includes a processor that is configured to provide an interface for allowing a user to select from a plurality of different examinations, acquire past passing records for a selected examination from a database and extract significant data from the past passing records by using a statistical method, and instruct a generative artificial intelligence model to generate responses to additional questions based on a prompt received from the user.

### CROSS-REFERENCE TO RELATED APPLICATION

This application is based on and claims priority under 35 USC 119 from Japanese Patent Application No. 2025-045260 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional examination preparation systems mainly provide static question sets, simple score aggregation, and basic progress tracking. Such systems insufficiently utilize rich historical pass records and past examination questions to derive statistically significant information that can directly support a user in efficiently reaching a passing level. In addition, when a user has specific or follow-up questions during study, conventional systems are not capable of flexibly generating high-quality responses tailored to the user's prompts.

Furthermore, conventional systems generally do not consider the user's emotional state, and therefore cannot adapt feedback to maintain the user's motivation or provide encouragement when the user experiences frustration or anxiety. As a result, it is difficult for the user to receive dynamically optimized guidance that leverages statistical analysis, machine learning, and emotional understanding in an integrated manner.

### SUMMARY

In order to solve the above-described problems, an embodiment of the present invention provides a system comprising a processor, wherein the processor is configured to provide an interface that allows a user to select from a plurality of different examinations, acquire past passing records for a selected examination from a database, and extract significant data from the past passing records by using a statistical method. The processor is further configured to instruct a generative artificial intelligence model to generate responses to additional questions based on a prompt received from the user, thereby enabling flexible and context-aware support during study. In addition, according to another aspect, the processor is configured to dynamically adjust, by using a machine learning algorithm, a method for examining the past passing records and past examination questions in accordance with the type of the selected examination, so that analysis and question selection can be optimized per subject or exam category. Furthermore, according to another aspect, the processor is configured to analyze emotional data of the user by using an emotion recognition algorithm and generate positive feedback based on an analysis result of the emotional data, thereby supporting the user's learning process while maintaining or improving the user's motivation.

The term “system” refers to an arrangement including at least one processor and, optionally, one or more memories, databases, input/output devices, communication interfaces, and other hardware and software components configured to perform the functions described in the present specification and claims.

The term “processor” refers to a hardware component or a combination of hardware components, such as a central processing unit (CPU), a graphics processing unit (GPU), a digital signal processor (DSP), or another computation unit, which executes instructions to implement the operations and algorithms described in the present specification and claims.

The term “interface” refers to a hardware and/or software mechanism that enables interaction between a user and the system, such as a graphical user interface, a web page, a mobile application screen, a command line interface, or another input/output interface that allows the user to select examinations and input prompts.

The term “user” refers to a human individual who operates a terminal or other client device to interact with the system, including selecting examinations, providing prompts, and receiving generated responses and feedback.

The term “examination” refers to an assessment, test, or exam administered for the purpose of evaluating knowledge, skills, or abilities in one or more subjects, including but not limited to school entrance examinations, qualification tests, certification exams, or standardized tests.

The term “past passing records” refers to stored data representing historical examination performance of examinees who have passed a given examination, such as scores, pass/fail results, distributions, and other statistical attributes related to successful outcomes.

The term “database” refers to any structured collection of data that can be electronically stored, updated, and queried, including relational databases, NoSQL databases, data warehouses, or other data storage systems used to store past passing records, past examination questions, and related information.

The term “statistical method” refers to any algorithm or procedure based on statistics, including but not limited to averaging, variance and distribution analysis, correlation analysis, regression analysis, clustering, or other quantitative techniques used to extract significant data or patterns from past passing records.

The term “significant data” refers to information derived from past passing records that is determined, by the statistical method, to be relevant or useful for supporting examination preparation, such as indicators of typical passing scores, commonly mastered topics, question difficulty distributions, or correlations between question types and passing outcomes.

The term “generative artificial intelligence model” refers to an artificial intelligence model, such as a large language model or other generative model, configured to generate text, answers, or other outputs in response to input data, including prompts provided by the user, by learning patterns from a training dataset.

The term “prompt” refers to an input provided by the user to the system, such as a question, instruction, or request, which is supplied to the generative artificial intelligence model as a basis for generating one or more responses.

The term “response” refers to an output generated by the generative artificial intelligence model based on the prompt, including but not limited to answers to questions, explanations, hints, study guidance, or other textual or multimedia content returned to the user.

The term “machine learning algorithm” refers to any algorithm that adjusts parameters or models based on data to improve performance on a task, including but not limited to supervised learning, unsupervised learning, reinforcement learning, neural networks, decision trees, gradient boosting, or other learning methods used to dynamically adjust examination analysis methods.

The term “method for examining the past passing records and past examination questions” refers to a processing procedure that analyzes historical examination data, including past passing records and past examination questions, to derive metrics, select questions, or otherwise determine information relevant to examination preparation.

The term “type of the selected examination” refers to a category or classification of an examination, such as subject area, exam level, format, or target qualification, which can influence how the past passing records and past examination questions are analyzed and processed.

The term “past examination questions” refers to questions that have been previously used in administered examinations, including their texts, possible choices, correct answers, model answers, associated difficulty levels, and metadata relating to topics, years, or formats.

The term “emotional data” refers to data indicative of the user's emotional state, which may be derived from user interactions, facial expressions, voice characteristics, physiological signals, textual input, or other observable indicators processed by an emotion recognition algorithm.

The term “emotion recognition algorithm” refers to a software algorithm configured to analyze emotional data and infer or classify an emotional state of the user, such as frustration, anxiety, confidence, satisfaction, or other affective conditions.

The term “positive feedback” refers to feedback generated by the system that is intended to encourage, motivate, or reassure the user, and may include praise, supportive comments, suggestions for improvement presented in an encouraging manner, or other messages designed to maintain or enhance the user's motivation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

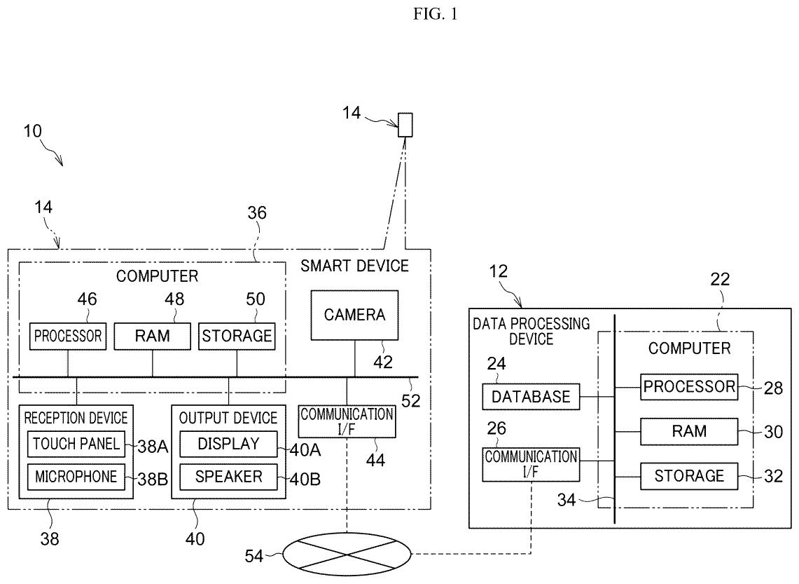

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

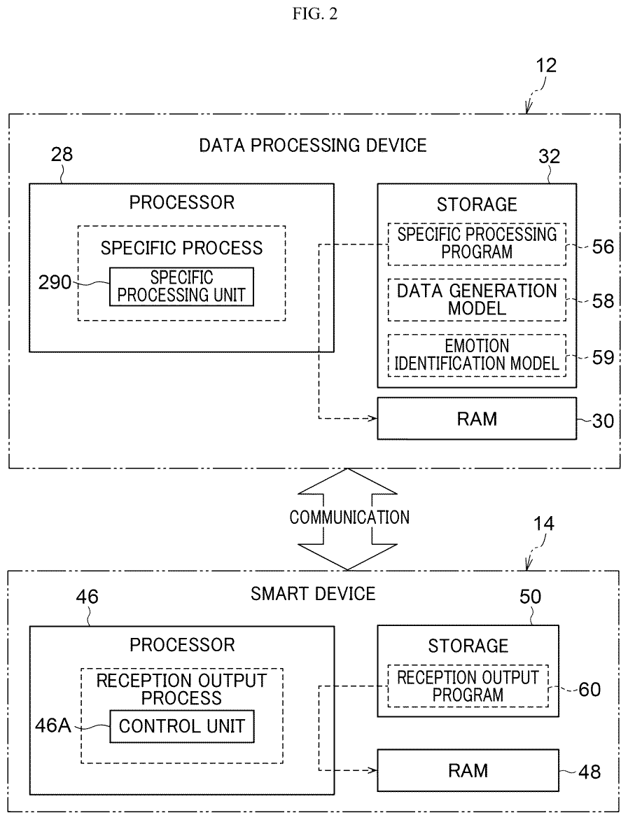

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60.

The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented exam preparation systems generally operate as static content delivery platforms that retrieve past questions and answers from storage and present them to a user in a fixed manner. Such systems typically lack sophisticated, data-driven mechanisms for identifying which tasks are actually critical to passing a given evaluation, and they do not dynamically tailor their processing logic or content selection based on the type of evaluation, historical performance distributions, or individual user behavior. As a result, large amounts of stored exam data, including decades of past results and questions, remain under-utilized from a computational perspective, and the system's output is often only a simple listing of questions rather than a technically optimized learning plan.

From the standpoint of computer technology, existing systems also fail to tightly integrate statistical processing, machine learning, and generative artificial intelligence in a coordinated data pipeline. In many implementations, database retrieval, analytics, and content generation are performed as loosely coupled or manual operations, which leads to inefficient use of computing resources, redundant data transfers, and an inability to automatically refine algorithms and prompts over time based on accumulated usage data. The systems do not adapt their internal processing parameters in response to changing data distributions or user interaction patterns, resulting in suboptimal performance and scalability.

Furthermore, conventional architectures do not provide a systematic mechanism by which a server can automatically construct structured training or support data, convert that data into a machine-consumable prompt sentence, and feed it into a generative AI model in a feedback-controlled way. Without such a mechanism, the quality and relevance of AI-generated explanations and recommendations depend heavily on ad-hoc prompt engineering performed by human operators, rather than on reproducible, programmatic generation of prompts from structured analytics outputs. This introduces variability and reduces the reliability and repeatability of the system's recommendations.

Additionally, many prior systems do not record and exploit detailed user operation history and learning status information at the server side as first-class analytic inputs. Interaction logs, such as which questions are viewed, which explanations are expanded, and which topics are repeatedly revisited, are either not captured or are only used for superficial reporting.

They are not systematically integrated into the server's algorithmic pipeline to dynamically adjust statistical models, learning algorithms, or generative AI prompt generation.

Consequently, the system cannot technically optimize its own internal behavior to provide more precise and computationally efficient personalization over time.

Thus, there is a need for an improved computer-implemented system that: (i) programmatically transforms large-scale exam performance and question data into structured analytics identifying tasks that contribute to success criteria; (ii) automatically generates prompt sentences and structured inputs for a generative AI model based on those analytics; (iii) tightly integrates generative AI outputs back into a structured learning support dataset; and (iv) uses accumulated operation history and learning status data to dynamically adjust statistical and learning algorithm parameters, thereby improving the technical performance, adaptability, and efficiency of the overall exam support platform.

The specific processing by the specific processing unit 290 of the data processing device 12 in Example 1 is realized by the following means.

The present invention provides a server comprising a processor configured to provide, to a user via an information processing terminal, an information display and input interface through which the user selects an evaluation target; to obtain, from a relational data management device by using a query language, past performance information and past question information associated with the selected evaluation target; to store the obtained performance information and question information as tabular data by using a numerical processing program executed on a general-purpose computation device and apply statistical methods and learning algorithms to the tabular data so as to extract tasks contributing to a success criterion and a set of questions having high importance, and to obtain, from a knowledge storage device, model answer information and explanation information corresponding to the set of questions; to generate structured data including the set of questions, the model answer information, and related statistical indicators, and to generate a prompt sentence based on the structured data; to input the prompt sentence and the structured data into a generative artificial intelligence model, cause the generative artificial intelligence model to output response data including explanation information and learning recommendation information for each question, and integrate the obtained response data with the structured data as learning support data; to convert the learning support data into a standardized description format or a standardized display format, transmit the converted data to the information processing terminal, and cause the information processing terminal to display tasks to be preferentially learned to satisfy the success criterion, the model answer information, and the explanation information generated by the generative artificial intelligence model; and to accumulate, in a recording device, operation history information and learning status information of the user, and dynamically adjust parameters of the statistical methods and the learning algorithms based on the accumulated information. This enables the server to technically improve the efficiency and effectiveness of exam-related data processing by automatically transforming large-scale performance and question records into optimized learning tasks, generating and refining AI prompts and explanations in a reproducible, data-driven manner, and adaptively tuning its analytics and content-generation pipeline based on real-time usage data, thereby enhancing personalization, computational resource utilization, and overall system performance.

The term “system” refers to an arrangement of one or more computing devices, storage devices, communication interfaces, and software modules that cooperate to execute the functions described in the claims.

The term “processor” refers to one or more hardware processing units, such as a central processing unit or a processing core, configured to execute instructions stored in a memory to perform the operations described in the claims.

The term “user” refers to a human operator who interacts with the system through an information processing terminal to request, receive, and utilize exam-related information.

The term “information processing terminal” refers to an electronic device, such as a workstation, a portable computer, a tablet, or a smartphone, that includes at least one processor, a display, an input interface, and a communication interface, and that is configured to communicate with the server.

The term “information display and input interface” refers to a graphical or textual user interface presented on the information processing terminal that allows the user to view information provided by the system and to input selections or commands, including selection of an evaluation target.

The term “evaluation target” refers to any assessment entity for which performance is evaluated, such as an examination, a test section, a subject area, or a category of questions.

The term “relational data management device” refers to a data storage and management system that stores structured data in associated tables and processes requests expressed in a query language to retrieve, insert, update, or delete records.

The term “query language” refers to a formal language, such as a structured query language, used to specify retrieval conditions and operations for accessing data in the relational data management device.

The term “past performance information” refers to data records representing historical results associated with an evaluation target, including at least scores, pass or fail indicators, and optionally additional metadata such as time, topic, or examinee attributes.

The term “past question information” refers to data records representing previously administered questions associated with an evaluation target, including at least question texts, identifiers, topic classifications, and optionally difficulty indicators or solution attributes.

The term “general-purpose computation device” refers to a computing platform comprising at least one processor, a memory, and input/output interfaces, configured to execute various programs not limited to a single dedicated function.

The term “numerical processing program” refers to application software or a software library executed by the general-purpose computation device to handle tabular or numerical data, perform calculations, and support operations such as filtering, aggregation, and statistical analysis.

The term “tabular data” refers to information arranged in a structured format comprising rows and columns, where each row represents a record and each column represents a field, enabling indexed access and computational processing.

The term “statistical methods” refers to algorithmic procedures for analyzing data, such as computing distributions, averages, variances, correlations, and other statistical indicators used to characterize performance and question properties.

The term “learning algorithms” refers to computational algorithms, including machine learning algorithms, that infer patterns or models from data and that are used to identify or rank tasks, questions, or topics according to their contribution to success criteria.

The term “success criterion” refers to a predefined condition or threshold that indicates satisfactory performance in relation to an evaluation target, such as achieving a passing score or meeting a minimum competency standard.

The term “tasks contributing to a success criterion” refers to question types, topics, skills, or specific questions that are determined, through statistical methods and learning algorithms, to have a significant impact on whether the success criterion is satisfied.

The term “set of questions having high importance” refers to a subset of questions selected from the past question information that, according to the applied statistical methods and learning algorithms, are particularly influential for achieving the success criterion.

The term “knowledge storage device” refers to a storage system, such as a database or a file storage apparatus, that maintains structured or semi-structured knowledge data, including model answer information and explanation information.

The term “model answer information” refers to data representing exemplary or reference answers for questions, used as a standard or target response in the context of exam preparation or evaluation.

The term “explanation information” refers to data describing reasoning, solution steps, clarifications, or conceptual descriptions that help a user understand a question, its model answer, and related concepts.

The term “structured data” refers to data organized according to a defined schema or format, such as records having fixed fields for question identifiers, texts, model answers, explanations, and statistical indicators, thereby enabling machine processing and transformation.

The term “statistical indicators” refers to numeric or categorical values derived from data using statistical methods, including but not limited to pass rates, average scores, difficulty indices, and frequency counts.

The term “prompt sentence” refers to a machine-readable text or data string that encodes instructions, context, and structured content for input to a generative artificial intelligence model in order to obtain a desired output.

The term “generative artificial intelligence model” refers to a computational model, implemented as software on one or more processors, configured to generate natural-language or structured outputs in response to textual or structured inputs by using learned parameters.

The term “response data” refers to output information produced by the generative artificial intelligence model in response to the prompt sentence and structured data, including at least explanation information and learning recommendation information.

The term “learning recommendation information” refers to guidance data generated to assist the user in planning or prioritizing learning activities, such as recommended order of study, focus areas, and suggested practice strategies.

The term “learning support data” refers to data obtained by integrating structured data with response data from the generative artificial intelligence model, including questions, model answers, explanations, and learning recommendations, formatted for presentation or further processing.

The term “standardized description format” refers to a machine-readable data organization pattern, such as a defined markup or serialization format, that enables consistent interpretation and transmission of learning support data.

The term “standardized display format” refers to a layout or representation scheme suitable for rendering the learning support data on an information processing terminal in a consistent, structured manner.

The term “operation history information” refers to records of user interactions with the system, including but not limited to selected evaluation targets, accessed questions, opened explanations, and invoked functions.

The term “learning status information” refers to data that represents a state of progress or engagement of the user, such as completed questions, viewed explanations, repeated topics, and inferred mastery levels.

The term “recording device” refers to any storage component or subsystem, including non-volatile memory or magnetic storage, configured to store operation history information, learning status information, and other system data.

The term “parameters of the statistical methods and the learning algorithms” refers to numeric or symbolic values controlling behavior of the statistical methods and learning algorithms, such as thresholds, weights, model coefficients, and selection criteria that can be adjusted based on accumulated data.

The term “type of the evaluation target” refers to a classification of the evaluation target, including categories such as subject area, level, format, or domain, which influence how performance and question data are analyzed.

The term “topic categories” refers to conceptual groupings or labels assigned to questions or tasks, such as subject topics, skill areas, or content domains, used to structure and interpret question sets.

The term “prompt sentence generation conditions” refers to rules, parameters, or constraints that govern how the prompt sentence is constructed from structured data, statistical indicators, and user-related information for input to the generative artificial intelligence model.

The term “optimized question selection” refers to the process, controlled by the processor, of automatically selecting questions that are most suitable for a given user or evaluation target, based on statistical analysis, learning algorithms, and accumulated interaction data.

The term “model answer presentation” refers to the operation of providing model answer information to the user in a form and order determined by the system, possibly together with related explanations and indicators.

The term “explanation generation” refers to the production, by the generative artificial intelligence model under control of the processor, of explanation information and learning recommendation information for questions or tasks based on the prompt sentence and structured data.

In one embodiment, a server includes at least one processor, a main memory, a non-volatile storage device, and a network interface. The server executes an operating system such as a general-purpose server operating system and an application stack including a web application framework, a relational database management system client library, a numerical processing library, and a generative AI client library. The server communicates with at least one terminal over a network such as the Internet by using a protocol such as HTTPS.

The terminal includes at least one processor, a display, a user input device such as a touchscreen, keyboard, or pointing device, a main memory, and a network interface. The terminal executes a browser or an application that renders a graphical user interface, communicates with the server, and displays information to a user.

The user operates the terminal to access a web page or application screen provided by the server. The terminal displays an interface that includes graphical components such as dropdown lists, check boxes, and search fields that enable the user to specify an evaluation target, a time range, and optional topic filters. The terminal transmits the user's selections to the server as structured request data over the network.

The server uses the processor and main memory to receive the request data and to validate the evaluation target and associated parameters. The server uses a relational database management system such as a general-purpose relational database running on the same machine or on a separate storage machine. The server uses a query language such as a structured query language to retrieve past performance information and past question information corresponding to the selected evaluation target and specified conditions. The server retrieves fields including at least question identifiers, question texts, topic classifications, timestamps, scores, pass or fail indicators, difficulty indices, and metadata describing exam sessions.

The server loads the retrieved data into a tabular data structure held in memory, for example as an in-memory table managed by a numerical processing library. The server interprets rows as individual records and columns as fields such as score, topic, question type, difficulty index, and pass indicator. The server applies statistical methods such as calculation of means, variances, histograms, and probability distributions to the tabular data. The server also applies learning algorithms, including at least a supervised or semi-supervised model, to estimate relationships between question attributes and the success criterion defined by a passing score or threshold.

The server, for example, uses features such as topic, question type, year, difficulty index, answer length, and historical correct-answer rate as input variables to a trained machine learning model such as a decision tree, gradient boosting model, or neural network model.

The server uses the output of the model to compute importance scores for each question or topic. The server identifies tasks contributing to the success criterion by ranking questions and topics based on importance scores and by applying thresholds that can be adjusted by parameters stored in configuration data.

The server employs a non-conventional data-structuring process by integrating relational data, statistical indicators, and machine-learning outputs into a unified structured data object.

The server associates each question with a unique identifier and attaches fields that include the model answer information, explanation information retrieved from a knowledge storage device, and computed statistical indicators such as pass rate, difficulty index, and importance score. The server persists this structured data object in main memory or in a temporary storage area to minimize repeated access to the relational database, thereby reducing I/O overhead and latency.

The server uses the structured data object as the basis for generating at least one prompt sentence for a generative AI model. The server aggregates question texts, model answers, and key indicators into a textual context and constructs a prompt sentence according to generation rules that specify the order, grouping, and annotation format. The server applies generation conditions that depend on the evaluation target type, distribution of past performance, and usage patterns accumulated from operation history information and learning status information. By using these conditions, the server dynamically adjusts which questions are included in the prompt, which indicators are emphasized, and how many examples are provided to the generative AI model.

The server uses a generative AI model implemented as a multi-layer neural network, such as a transformer-based language model, comprising an input embedding layer, multiple self-attention layers, feed-forward layers, and an output projection layer. The server configures the model with parameters including vocabulary size, number of layers, number of attention heads, hidden dimension, and maximum sequence length. The server uses training data that consists of text sequences representing question-answer pairs, explanations, and exam-related narratives, and uses a loss function such as cross-entropy to measure prediction error on the next token or sequence. During training, the server updates model weights by a gradient-based optimization method such as stochastic gradient descent or an adaptive variant, using backpropagation to propagate errors.

The server, when deployed in inference mode, does not retrain the generative AI model for each user request but uses a fine-tuned model that has been trained offline. The server sets inference parameters such as temperature, top-k or top-p sampling values, and maximum output length. The server transmits the prompt sentence and, in some cases, selected structured data fields encoded as text to the generative AI model by using a generative AI client library and a network interface to a model-serving endpoint.

The server receives response data from the generative AI model that includes explanation information and learning recommendation information for each question or for groups of questions. The server aligns the response data with the structured data object by matching question identifiers or positional indices. The server appends fields such as AI-generated explanation text, key-concept summaries, and recommended learning order to each question record. The server thereby forms learning support data that combines deterministic analytics outputs, stored knowledge, and generative AI outputs in a coherent data structure.

The server stores operation history information and learning status information in a recording device. The server, for example, logs which questions are displayed, which explanations are expanded, which filters are applied, and which recommended tasks are completed by the user.

The server aggregates these logs to compute user-specific and population-level statistics such as frequency of access per topic and average time spent per question. The server uses these aggregated statistics as additional features or conditions for updating parameters of the statistical methods and learning algorithms.

The server, in some embodiments, periodically recalibrates thresholds for importance scores and recomputes topic weights used in the selection of tasks contributing to the success criterion. The server uses unsupervised clustering methods such as k-means or hierarchical clustering on high-dimensional feature vectors representing questions and user interactions.

By clustering questions based on both intrinsic attributes and interaction-derived metrics, the server identifies groups of questions that are persistently difficult or highly discriminative for success.

The server then adjusts prompt-generation rules so that questions from clusters associated with strong correlation to success or persistent user difficulty are included more frequently or placed earlier in the prompt sentence. This non-trivial feedback from user interaction data to prompt construction rules yields technical effects such as improved relevance of AI-generated explanations and reduced need for repeated model calls, thereby lowering communication bandwidth usage and latency per session.

The terminal receives learning support data formatted in a standardized description or display structure such as a markup-like hierarchy. The terminal translates the structure into visible components using its processor and graphical subsystem. The terminal displays question texts, model answers, statistical indicators, and AI-generated explanations in a layout optimized for readability and comparison. The terminal allows the user to filter and sort the displayed items based on attributes such as topic, difficulty, or importance score. The terminal may locally cache subsets of the learning support data to reduce redundant network requests, which further diminishes communication load and accelerates response time.

The user interacts with the displayed content by scrolling, selecting questions, opening or closing explanation panels, and indicating completion of tasks. The user, in some embodiments, can trigger additional requests for deeper explanations or alternative solution approaches for specific questions. The terminal transmits these additional requests to the server, and the server may generate new prompt sentences that incorporate prior AI-generated text and updated operation history information as context, thereby enabling iterative refinement of AI output.

The server, by using a unified and optimized data flow from relational storage to numerical analysis, machine learning evaluation, structured data construction, and generative AI interaction, improves computational efficiency compared to systems that treat each stage independently. Because the server maintains the data in compact tabular and vectorized formats, the server can perform batch analytics and prompt construction with reduced memory copying and serialization overhead. The server also reduces redundant AI calls by reusing structured context and selectively updating segments affected by user actions.

In another embodiment, the server employs a more explicit feature-engineering module. The server converts question attributes and historical performance metrics into numerical feature vectors that include encoded topic indices, normalized difficulty scores, time-based trends, and user-specific familiarity estimates. The server uses these feature vectors as input to a ranking model that outputs a continuous importance score. The server uses a monotonic transformation or calibration function to map raw scores to probabilities that a question is critical for passing the exam. This transformation allows the server to apply consistent thresholds across different evaluation targets and time ranges, thereby stabilizing selection behavior.

In an alternative embodiment, the server hosts multiple generative AI models with different capacities or specializations, such as a smaller model for preliminary summarization and a larger model for detailed explanations. The server uses internal heuristics based on importance scores and user behavior to decide which model to invoke for a given set of questions. The server, for instance, may use the smaller model for low-importance questions and the larger model for high-importance questions, thereby reducing overall compute load without degrading the quality of explanations for critical content. This selective invocation of models results in improved throughput and reduced latency on the server infrastructure.

The server's integration of machine-learning-based importance scoring with prompt-generation rules and a structured response-mapping procedure differs from mere human-like exam analysis automation. The server implements a closed-loop optimization mechanism at the level of data structures and algorithms. The server uses structured data objects and algorithmic rules that are not normally applied in manual exam preparation, such as high-dimensional feature ranking, cluster-based selection, and prompt conditioning based on cumulative interaction metrics. These operations are inherently machine-centric and result in technical improvements in data management, storage locality, and communication efficiency.

The server also provides error-reduction benefits by using statistical aggregation over large datasets. The server smooths noisy measurements of difficulty and pass rates by applying regularization techniques or Bayesian estimators, and then feeds these stabilized indicators into the selection and prompt-generation pipeline. As a result, the system reduces the variance of importance estimates and thereby generates more reliable prompts and explanations. By reducing noise at the data and model-input level, the server decreases the likelihood of misleading AI outputs that would otherwise arise from raw, unprocessed statistics.

The server, in order to further improve computational performance, schedules background processes that periodically precompute analytics for frequently selected evaluation targets.

The server pre-generates structured data objects and candidate prompt templates and stores them in a fast-access cache. When a user initiates a session for one of these evaluation targets, the server reuses the precomputed structures and only performs incremental updates, such as incorporating the user's specific time range or topic filters. This precomputation reduces the processing time required for each request and contributes to scalability when many users access the system concurrently.

A concrete example of a prompt sentence generated by the server is as follows:

“Using the past 10 years of university entrance exam English data (question texts, model answers, scores, and pass/fail flags), identify problems around the passing score and explain why mastering these problems is critical for passing. For each selected problem, rewrite the model answer if necessary, and produce a clear explanation and one study tip. Output the result in a logically structured narrative that can be directly shown to students.”

In another example, the server generates a more focused prompt sentence:

“Based on university entrance exam English grammar questions from 2018 to 2023, around the passing line, generate explanations and model answers that highlight the most critical grammar patterns for passing the exam. Prioritize questions with high importance scores and high difficulty indices, and provide concise study recommendations for each pattern.”

By constructing the prompt sentence from structured analytics and by adjusting its content and emphasis using algorithmically determined parameters, the server leverages generative AI in a way that is tightly coupled to the internal data-processing pipeline and not merely as a generic text generator. This coupling provides a technical effect in the form of reproducible, machine-controlled configuration of AI behavior, which improves consistency, reduces manual tuning, and enables automated adaptation over time.

The terminal, by rendering data in a structured and interactive format, supports efficient human-computer interaction and lowers the cognitive load on the user. However, the core improvement resides in the server-side processing architecture: the server performs specific transformations of data structures, statistical analyses, and algorithmic adjustments that transform raw exam records into an optimized, AI-augmented learning support dataset. This architecture, in combination with the described neural network configuration and prompt-generation logic, results in a technical improvement to computer-based exam support systems in terms of processing speed, output relevance, and resource utilization, thereby satisfying requirements for a concrete technological implementation.

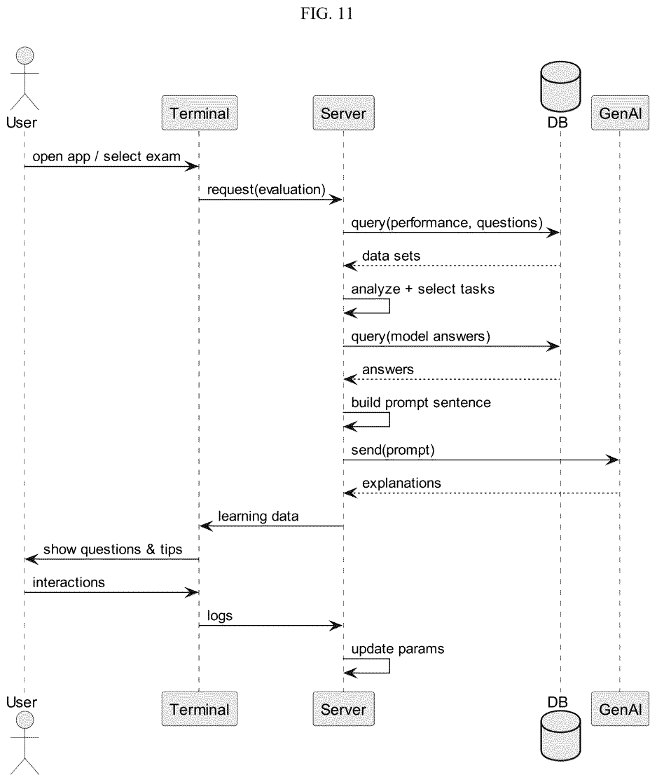

The following describes the processing flow using FIG. 11.

### Step 1:

User operates the terminal to access an exam support screen provided by the server.

User, as input, provides an evaluation target, a time range, and optional topic filters by selecting items in dropdown menus, entering text in search boxes, and pressing a confirmation button.

Terminal, based on this input, constructs a structured request including fields such as evaluation_target_id, year_from, year_to, and topic_filter, and transmits this request to the server over a network using an HTTPS POST operation.

Terminal outputs a formatted request message that serves as input to the server.

### Step 2:

Server receives the request message from the terminal via the network interface.

Server, as input, obtains the structured request containing evaluation_target_id, year_from, year_to, and topic_filter.

Server validates the input by checking that the evaluation_target_id exists in a configuration table, confirming that the year range is within allowed limits, and normalizing any topic_filter strings.

Server outputs a validated request object, or an error response if validation fails; when validation succeeds, the validated request object becomes the input for database retrieval.

### Step 3:

Server queries a relational data management device to retrieve past performance information and past question information.

Server, as input, uses the validated request object, including evaluation_target_id, year_from, and year_to, to construct parameterized query language statements.

Server executes, for example, a first query to retrieve performance records (scores, pass/fail flags, timestamps) and a second query to retrieve question records (question_text, topic, difficulty_index, question_type, year).

Server outputs two sets of records: a performance dataset and a question dataset, each structured as row-and-column tables, and passes these as input to a numerical processing module.

### Step 4:

Server converts the retrieved datasets into tabular data structures managed by a numerical processing program.

Server, as input, receives the performance dataset and the question dataset in the form of query results.

Server loads these results into in-memory tables, assigning explicit column types for fields such as numeric scores, categorical topics, and boolean pass indicators; the server joins or links performance records and question records using shared identifiers, and removes incomplete rows where essential fields are missing.

Server outputs a unified tabular dataset where each row corresponds to a question instance with associated performance metrics, which then serves as input to statistical analysis.

### Step 5:

Server performs statistical analysis to compute indicators related to exam success.

Server, as input, uses the unified tabular dataset including scores, pass indicators, topics, difficulty indices, and timestamps.

Server computes, for example, average scores per topic, pass rates per question, difficulty distributions over years, and histograms of scores around the passing threshold; the server may calculate moving averages or smoothed estimates to reduce noise.

Server outputs a set of statistical indicators for each question and topic (such as pass_rate, mean_score, and difficulty_index_adjusted), and attaches these indicators as additional columns to the tabular dataset.

### Step 6:

Server applies learning algorithms to estimate the importance of questions and topics for meeting a success criterion.

Server, as input, uses the enriched tabular dataset containing intrinsic attributes (topic, question_type, difficulty_index) and derived indicators (pass_rate, mean_score, variance, and proximity to the passing score).

Server constructs feature vectors for each question, normalizes numeric features, encodes categorical variables, and evaluates a ranking model or classification model to determine how strongly each question correlates with passing; the server may use pre-trained model parameters and apply them to the feature vectors.

Server outputs an importance score or probability value for each question and topic, which is appended to the dataset as an importance_score column and becomes the input for selection of critical tasks.

### Step 7:

Server selects tasks contributing to the success criterion and forms a high-importance question set.

Server, as input, uses the tabular dataset annotated with importance_score, pass_rate, difficulty indices, and proximity to the passing score.

Server filters questions by applying threshold rules such as selecting questions with importance_score above a configurable value and within a score range around the passing threshold; the server may sort questions by descending importance_score and limit the set to a predetermined maximum size.

Server outputs a subset of question records that constitute the high-importance question set, which serves as input for model answer retrieval.

### Step 8:

Server retrieves model answer information and existing explanation information corresponding to the high-importance question set.

Server, as input, takes the list of question identifiers from the high-importance question set.

Server issues a query language statement to a knowledge storage device to obtain model answers and base explanations for each identifier, then merges the returned records with the high-importance question set using identifier matching.

Server outputs an augmented high-importance question set that includes question_text, model_answer, base_explanation, and associated indicators, ready for structured data construction.

### Step 9:

Server constructs a structured data object that aggregates analytic results and knowledge data.

Server, as input, uses the augmented high-importance question set containing question attributes, performance indicators, importance scores, model answers, and explanations.

Server organizes these fields into a structured representation, for example grouping by topic or difficulty, assigning ordered lists of questions, and encoding metadata such as evaluation_target_type and analysis_timestamp; the server ensures that each question record contains all required fields for downstream usage.

Server outputs a structured data object representing an analytics-enriched question set, which serves as the basis for prompt sentence generation.

### Step 10:

Server generates a prompt sentence for a generative AI model using the structured data object.

Server, as input, uses the structured data object and configuration parameters defining prompt templates and emphasis rules.

Server samples or selects a subset of questions and indicators from the structured data, formats them as readable text snippets, and inserts them into a predefined prompt template that specifies instructions, context, and desired output format; the server adjusts wording and ordering based on evaluation_target_type and distribution of importance_score values.

Server outputs a text-based prompt sentence that includes question examples, model answers, and key indicators, and this prompt sentence becomes input to the generative AI model.

### Step 11:

Server transmits the prompt sentence to a generative AI model and obtains response data.

Server, as input, uses the generated prompt sentence and, optionally, additional contextual text derived from the structured data object.

Server sends the prompt as a request to a model-serving endpoint through a generative AI client library, specifying inference parameters such as maximum output length and sampling strategy; the model processes the prompt and returns generated text containing explanations and learning recommendations.

Server outputs response data from the generative AI model, including per-question or per-pattern explanatory text, which serves as input for integration with the structured data object.

### Step 12:

Server integrates the response data with the structured data object to create learning support data.

Server, as input, receives the structured data object and the generated response data from the generative AI model.

Server parses the response text, associates explanations and recommendations with corresponding question identifiers or sections based on markers or ordering, and attaches AI-generated explanation fields and learning_recommendation fields to each question record.

Server outputs learning support data that merges analytic indicators, knowledge data, and AI-generated content into a unified representation suitable for presentation.

### Step 13:

Server converts the learning support data into a standardized format and prepares a response for the terminal.

Server, as input, uses the learning support data containing question_text, model_answer, indicators, and AI-generated explanations.

Server serializes this data into a standardized description or display format, such as a hierarchical structure describing sections, question items, and explanation blocks; the server may apply compression or partial selection to reduce payload size and organize data for efficient rendering.

Server outputs a formatted response payload that encodes the learning support data and sends it to the terminal via the network.

### Step 14:

Terminal receives the formatted response payload and renders a learning interface for the user.

Terminal, as input, obtains the structured response payload from the server over HTTPS.

Terminal parses the payload, creates user interface components such as lists, collapsible panels, and annotated labels for difficulty and importance, and arranges question texts, model answers, and AI-generated explanations on the display; the terminal may initialize local state to track which items are expanded or marked as completed.

Terminal outputs a fully rendered interactive screen that the user can view and manipulate for exam preparation.

### Step 15:

User interacts with the rendered learning interface to perform study activities.

User, as input, uses the display and input devices of the terminal to select questions, expand or collapse explanation sections, and indicate completion or rating of tasks.

User triggers additional actions such as requesting more detailed explanations or switching filters (for example, to show only high-difficulty questions), and the terminal records these interactions as operation events.

Terminal outputs updated view states and logs of user actions, which are transmitted back to the server as interaction data.

### Step 16:

Server records operation history information and learning status information and updates analytic parameters.

Server, as input, receives interaction data from the terminal, including which questions were viewed, which explanations were expanded, and which tasks were marked as completed.

Server stores this information in a recording device, aggregates it across sessions to compute usage metrics, and updates parameters of the statistical methods and learning algorithms, such as thresholds for importance_score, topic weights, or model selection rules; the server may adjust prompt-generation conditions to emphasize topics frequently causing difficulty.

Server outputs updated configuration and model parameters, which in subsequent executions modify the selection of tasks, formation of structured data, and generation of prompt sentences, thereby closing the feedback loop and improving system behavior over time.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented test preparation systems typically retrieve past examination questions and simple statistical data, and then display them to a user in a fixed, template-based manner. Such systems often rely on static question banks and pre-defined difficulty labels, without performing fine-grained correlation analysis between past results and specific questions. As a result, the systems are limited in their ability to identify, at the computing level, which questions are most strongly associated with achieving a passing score, and cannot adaptively focus computational resources on those questions that most effectively improve user performance.

Furthermore, known systems that incorporate generative artificial intelligence models generally use manually crafted prompts or fixed templates that are not systematically linked to the underlying structured evaluation data. These systems do not automatically compose or refine prompt sentences based on statistical features of the stored data or on user interaction history. Consequently, the computing infrastructure is not leveraged to dynamically generate machine-optimized prompt sentences that drive the generative artificial intelligence model to produce outputs that are tightly aligned with the user's examination objective and current proficiency level.

Additionally, conventional systems treat user behavior logs, such as browsing history and operation history, merely as reporting or analytics data, rather than as first-class inputs into the core computational pipeline. There is typically no feedback loop that uses these logs to update, at the algorithmic level, the extraction conditions and weighting coefficients for selecting key questions. Therefore, the ranking and selection logic of examination questions remains largely static, resulting in sub-optimal personalization and reduced effectiveness of the overall computer-implemented learning process.

Accordingly, there is a need for an improved computer-implemented system that: (i) automatically analyzes structured past evaluation data to compute statistical indicators and extract questions that contribute to a pass standard; (ii) automatically generates and refines, by computation, prompt sentences for a generative artificial intelligence model based on evaluation attributes and behavioral data; and (iii) continuously updates extraction conditions and weighting coefficients using user interaction logs so that the selection and presentation of questions are adaptively optimized by the computer over time. Such a system should provide a concrete improvement to the functioning of the computer system itself by introducing new data structures, computational workflows, and feedback mechanisms that enable more efficient and targeted processing of examination data, rather than merely automating a mental process.

The specific processing by the specific processing unit 290 of the data processing device 12 in Application Example 1 is realized by the following means.

The present invention provides a server comprising a processor and a storage device storing structured evaluation data and executable instructions, the processor being configured, by execution of the instructions, to perform operations including: transmitting presentation information to a terminal device to obtain, as machine-processable input, identification information of an evaluation target and evaluation condition information from a user; retrieving, from a structured information storage area of the storage device, past evaluation result information and past question information based on the identification information and the evaluation condition information; combining, using an information processing program, the past evaluation result information and the past question information to compute statistical information including at least occurrence frequency, correct answer rate, score contribution, and correlation with pass or fail; and extracting questions that contribute to a pass standard based on the computed statistical information. The processor is further configured to acquire model answer information corresponding to the extracted questions from the structured information storage area; format the extracted questions and the corresponding model answer information into a machine-structured learning information representation; generate, based on the identification information of the evaluation target and the evaluation condition information, a prompt sentence to be input to a generative artificial intelligence model by embedding attribute information including at least an evaluation target name, a question period, and a question field into a natural-language instruction template; transmit the generated prompt sentence to an input/output interface of the generative artificial intelligence model and receive, from the generative artificial intelligence model, an improved prompt sentence; structure the extracted questions, the model answer information, and the improved prompt sentence as learning presentation information and transmit the learning presentation information to the terminal device via a communication interface; and accumulate, in the structured information storage area, browsing history information and operation history information of the user received from the terminal device, and update extraction conditions and weighting coefficients used for extracting the questions that contribute to the pass standard based on the accumulated history information. This enables the computer system to dynamically identify and prioritize examination questions that are statistically linked to successful outcomes, to automatically generate and refine prompt sentences for a generative artificial intelligence model in a data-driven manner, and to adapt the extraction and presentation logic over time using user interaction logs, thereby improving the efficiency, relevance, and technical performance of the computer-implemented test preparation process.

The term “processor” refers to a hardware information processing unit, such as a central processing unit or a logic processing circuit, that executes computer-readable instructions to perform arithmetic operations, control operations, and data processing operations.

The term “terminal device” refers to an information processing apparatus operated by a user, such as a portable communication apparatus, a display-equipped computing apparatus, or another client-side device, that communicates with the server via a communication network and presents information to the user.

The term “evaluation target” refers to a test, examination, assessment, or other evaluation category defined in the system, which can be selected by the user and for which past evaluation data and question data are stored.

The term “evaluation condition information” refers to machine-processable parameters associated with an evaluation target, such as a time period, difficulty level, subject field, or other filter condition, that specify a subset or a characteristic of the evaluation data to be processed.

The term “structured information storage area” refers to a logically organized data storage region within a storage device, such as a database or a structured file, in which evaluation result information, question information, model answer information, and user history information are stored in a format that can be queried and processed by programs.

The term “past evaluation result information” refers to stored data representing outcomes of prior evaluations, including at least scores, pass/fail indicators, dates, and identifiers associated with examinees and questions.

The term “past question information” refers to stored data representing examination items used in past evaluations, including at least question identifiers, question texts, answer choices, correct answers, and associated metadata such as year and topic.

The term “statistical information” refers to numerical or categorical indicators computed by the processor from evaluation result information and question information, including at least occurrence frequency, correct answer rate, score contribution, and correlation with pass or fail.

The term “questions that contribute to a pass standard” refers to questions that the processor selects, based on statistical information, as having a predetermined level of association with achieving a passing score or exceeding a score threshold.

The term “model answer information” refers to stored answer texts and related explanation data that are designated as exemplary or reference answers to corresponding questions and that are used by the system for learning support.

The term “learning information structure” refers to a data representation in which each of a plurality of questions is associated with corresponding model answer information and related metadata, formatted so that it can be transmitted to and rendered by a terminal device for learning purposes.

The term “prompt sentence” refers to a natural-language instruction string generated by the processor and intended to be input to a generative artificial intelligence model to request generation, modification, or explanation of content related to an evaluation target.

The term “generative artificial intelligence model” refers to a machine-implemented model based on artificial intelligence techniques, such as a neural network model, that receives an input including a prompt sentence and outputs generated content including at least natural-language text.

The term “attribute information” refers to data describing properties of an evaluation target or evaluation condition, including at least an evaluation target name, a question period, a question field, and similar descriptors used to parameterize a prompt sentence.

The term “natural-language instruction template” refers to a predefined text pattern expressed in a human language, containing variable portions into which attribute information is embedded by the processor to form a specific prompt sentence.

The term “input/output interface of the generative artificial intelligence model” refers to an application programming interface or communication interface through which the processor sends a prompt sentence to the generative artificial intelligence model and receives generated content, including an improved prompt sentence, from the model.

The term “improved prompt sentence” refers to a modified version of a prompt sentence that is generated by the generative artificial intelligence model in response to an instruction to improve clarity, effectiveness, or suitability for a specific generation task.

The term “learning presentation information” refers to a data set structured by the processor that includes at least extracted questions, associated model answer information, and an improved prompt sentence, and that is transmitted to a terminal device for display to the user.

The term “communication interface” refers to a hardware and software combination that enables data exchange between the server and one or more terminal devices via a communication network, using protocols such as a packet communication protocol.

The term “browsing history information” refers to usage data indicating which learning presentation information or which questions the user displayed or viewed on the terminal device and for what duration.

The term “operation history information” refers to usage data indicating user interactions with the terminal device, such as selection operations, answer input operations, marking operations, or other UI operations performed in connection with displayed content.

The term “extraction conditions” refers to selectable or adjustable parameters used by the processor when filtering and ranking questions, including thresholds for statistical indicators and selection rules for identifying questions that contribute to a pass standard.

The term “weighting coefficients” refers to numerical parameters used in computation of importance scores or ranking values for questions, the coefficients assigning relative importance to different statistical indicators such as occurrence frequency, correct answer rate, score contribution, and correlation with pass or fail.

The term “user behavior analysis processing” refers to processing performed by the processor to derive analytical indicators, such as proficiency estimates or interest levels, from browsing history information and operation history information.

The term “presentation order” refers to the sequence in which questions or learning items are arranged for display to the user on the terminal device.

The term “presentation frequency” refers to how often specific questions or learning items are presented or re-presented to the user within the learning presentation information.

The term “difficulty-level composition” refers to a distribution of difficulty levels among questions included in a learning presentation set, such as a ratio of easy, medium, and difficult questions.

The term “proficiency level of the user” refers to an estimated level of the user's knowledge or skill regarding a particular evaluation target, inferred by the processor from evaluation results, browsing history information, and operation history information.

In one embodiment, a server executes a computer program on a hardware platform that includes at least one central processing unit, a main memory, a non-volatile storage device, and a network interface. The server uses a general-purpose operating system, such as a UNIX-like operating system, and an application execution environment, such as a Python runtime. The server additionally uses a relational database engine, such as a lightweight relational database management system, to implement a structured information storage area, and a web application framework, such as a general server-side framework, to communicate with a terminal.

A terminal is, for example, a smartphone, a tablet device, or a personal computer, equipped with a display, an input unit such as a touchscreen or keyboard, a local processor, a memory, and a wireless or wired communication interface. The terminal executes a client program, such as a web browser or a native application, capable of rendering hypertext content and executing client-side scripts. A user operates the terminal to interact with the server.

Server stores, in the structured information storage area, multiple types of structured records, including at least evaluation master records, past evaluation result records, past question records, model answer records, and user history records. Server represents these records as relational tables, each row being identified by a primary key and associated with multiple attribute columns. For example, server stores, for each question, a question identifier, a text field, a topic code, a difficulty indicator, a year, and links to corresponding evaluation identifiers. Server stores past evaluation result information in a table that includes, for each examinee and each evaluation session, a total score, a pass/fail flag, a timestamp, and links to question-level response records. By structuring the data in a normalized schema, server reduces redundancy and improves query performance.

Server uses an information processing program written, for instance, in Python combined with a data analysis library to load query results into in-memory data structures, such as two-dimensional arrays or data frames. Server performs join operations on these data structures by matching question identifiers and evaluation session identifiers, thereby forming a composite structure that associates each question with aggregated outcome statistics from multiple examinees and multiple years.

Server computes, for each question, statistical information such as occurrence frequency, correct answer rate, score contribution, and correlation with pass or fail. Server calculates occurrence frequency as a count of evaluation sessions in which the question appears, correct answer rate as a ratio of correct responses among attempted responses, score contribution as an average or weighted average of points gained when the question is answered correctly, and correlation as a numerical measure, such as a correlation coefficient, between a binary pass/fail variable and a binary correct/incorrect variable for the question. Server may also compute more advanced indicators, such as mutual information or a discrimination index, using arithmetic operations on the two-dimensional arrays. These computations are performed iteratively across the dataset, and server stores the results in additional columns of the data frame.

Server then applies an importance scoring function that combines these statistical indicators using weighting coefficients. For example, server calculates a composite score for each question as a weighted sum of normalized occurrence frequency, normalized discrimination index, and normalized score contribution. Server initially sets the weighting coefficients to predetermined values and later updates them based on accumulated user history information.

By sorting the questions in descending order of the composite score, server identifies a set of questions that contribute to a pass standard. Server marks these questions as key questions and stores their identifiers in a dedicated data structure, such as an index list, within the memory.

Server retrieves model answer information corresponding to the key questions from the structured information storage area. Server links each question text with its model answer text and associated metadata, such as source type and explanation level, and constructs a learning information structure. This structure may be represented as a hierarchical object, in which each question node includes child nodes for the model answer, topic label, difficulty label, and computed statistics. By using a structured representation, server can efficiently filter, group, and serialize the learning information for transmission.

Server generates a prompt sentence intended for input to a generative AI model. Server holds, in a program memory, a natural-language instruction template that contains placeholder tokens for attribute information of an evaluation target. Server embeds attribute information, such as an evaluation name, a subject field, a year range, and a target proficiency level, into the template to obtain a specific prompt sentence. For example, server generates a prompt sentence such as:

“For the national university entrance examination in English, identify questions that define the passing line over the past 10 years and provide step-by-step model answers with explanations understandable for high school students.”

In another example, server generates a prompt sentence such as:

“Using historical data for a professional auditing examination, create 20 practice questions focusing on topics that distinguish high scorers from average scorers, and include concise model answers and brief rationales.”

In a further example, server generates a prompt sentence such as:

“From the last 5 years of the bar examination in civil law, select questions that are strongly correlated with passing scores and generate detailed essay-style model answers that highlight key legal principles and precedent patterns.”

Server may store multiple templates to support different types of instructions, such as generating additional practice questions, providing detailed explanations, or producing study plans.

Server communicates with a generative AI model through an input/output interface exposed as a network service. The generative AI model is, in one embodiment, a deep neural network configured as a transformer-based language model. The model comprises an embedding layer that maps discrete tokens to continuous vectors, a plurality of self-attention layers that compute attention weights over token sequences, feed-forward layers that transform intermediate representations, and an output layer that produces token probability distributions. The model is trained, prior to deployment, on a large corpus of text data using stochastic gradient descent or a variant thereof, with a loss function such as cross-entropy between predicted tokens and ground truth tokens. During training, the model updates weight parameters, including attention weight matrices and feed-forward layer weights, by backpropagating gradients of the loss function.

Server does not retrain the model in this embodiment but uses inference mode. Server sends the prompt sentence to the model together with optional system-level instructions, specifying, for example, that the model should refine the expression of the prompt sentence for clarity and effectiveness in exam preparation. Server receives from the model an improved prompt sentence that is typically more precise, coherent, or targeted. By offloading the language refinement to a specialized model with a large parameter space and pre-trained linguistic knowledge, server obtains prompt sentences that are more effective in guiding further content generation.

Server aggregates the key questions, model answers, and improved prompt sentence into a learning presentation information object. Server serializes this object into a transmission format agreed upon with the terminal, such as a structured text format. Server then transmits the serialized data over a network using a packet communication protocol. Terminal receives the data, parses the structure, and renders the questions and model answers on the display.

Terminal displays the improved prompt sentence in a separate region, for example as a selectable text area, so that the user can read, edit, and optionally copy the prompt sentence.

User interacts with the terminal by scrolling through the questions, selecting specific questions to view model answers, and marking questions as difficult or mastered. Terminal records these operations as operation history information, and also records which items are displayed and for how long as browsing history information. Terminal periodically or upon certain triggers transmits this history information back to the server. Server stores the received history information in the structured information storage area as user history records, associating them with user identifiers, evaluation identifiers, question identifiers, and timestamps.

Server performs user behavior analysis by applying algorithms to the accumulated history records. For example, server estimates a proficiency level of the user for each topic by calculating a combination of viewing time, correctness of answers (if answer input is available), and frequency of revisiting questions in that topic. Server may categorize users into proficiency bands based on these computed indicators. Server then uses these proficiency estimates to adjust weighting coefficients in the importance scoring function, giving more weight to questions that many successful users have reviewed frequently or marked as difficult. Server also adjusts the composition of question sets, increasing the proportion of moderately difficult questions for intermediate users and the proportion of challenging questions for advanced users.

By updating extraction conditions and weighting coefficients in response to actual user behaviors, server creates a feedback loop that directly changes how data is processed inside the system. This adjustment is not a mere business rule update but a modification of computational parameters that influence the internal ranking and selection algorithm. As a result, server can reduce the number of questions that need to be processed and transmitted for each session, thereby reducing computation load and network traffic, while still focusing on questions that have the highest estimated effect on exam success.

In another embodiment, server maintains, in memory, a cache of precomputed statistics and key question sets for frequent evaluation targets and condition combinations. When server receives new user history information, server selectively invalidates and recomputes only those cache entries that are sensitive to the updated statistics. This partial recomputation reduces redundant processing and improves throughput for large numbers of concurrent users.

In another embodiment, server introduces a domain-specific feature extraction step before sending information to the generative AI model. Server constructs a compact representation of a question by extracting, for instance, topic tags, difficulty levels, and statistical indicators, and by concatenating these as a structured textual summary. Server then embeds this summary into the prompt sentence, enabling the generative AI model to condition its output not only on the question text but also on machine-derived features that are not apparent to human readers. This structured conditioning leads to more relevant output, thereby reducing the number of iterations required to obtain suitable content and improving system efficiency.

The described architecture provides concrete technical improvements over conventional systems. Server uses specific data structures, such as normalized relational tables and vectorized in-memory arrays, combined with iterative numerical computations, to derive question-level importance scores. These computations lead to a more accurate identification of questions that contribute to a pass standard, which in turn reduces unnecessary processing and bandwidth. The tight integration between statistical computation, prompt sentence generation, and generative AI model interaction allows server to automatically construct machine-optimized queries that humans could not efficiently design at scale.

Moreover, by embedding computed statistics and user behavior features into the generation process, server enables the generative AI model to operate according to rules and feature combinations that differ from simple human heuristics. For example, server can instruct the model to generate explanations that emphasize concepts with high discrimination indices or to generate additional practice questions centered around question clusters with high mutual information values. This use of machine-derived features constitutes a non-conventional and non-routine application of AI within a computer system.

In another variant, server may employ different generative AI models for different purposes.

Server may use a larger, more expressive transformer model to refine prompt sentences and a smaller, resource-efficient model to generate short hints or summaries. Server selects a model based on factors such as latency requirements and available resources, and manages requests through a model selection module. This configuration enables server to balance accuracy and speed, achieving improved response times without significantly sacrificing quality.

In yet another embodiment, server may execute a post-processing module that programmatically checks the consistency of outputs from the generative AI model. Server applies rule-based checks, such as verifying that generated answers match correct answers in the database, and discards or flags inconsistent content. By implementing this automated verification step, server reduces the risk of propagating erroneous information and increases the reliability of the overall system.

The described system is not limited to a single hardware configuration. Server may be implemented as a cluster of physical machines connected by a high-speed network, with a load balancer distributing incoming requests. Terminal may be any client device capable of executing a browser or a native application. In each configuration, server and terminal cooperate to perform distributed processing: server performs heavy computation and data analysis, while terminal focuses on user interaction and local rendering. This division of labor reduces processing burden on user devices and enables consistent performance across a wide variety of terminal hardware.

Through these embodiments, server, terminal, and user jointly realize a computer-implemented test preparation environment in which data acquisition, statistical analysis, prompt sentence generation, generative AI interaction, and user behavior-driven feedback loops are precisely defined and executed. The system thereby improves processing efficiency, selection accuracy, and communication performance, and provides a concrete enhancement to the technical functioning of the underlying computer infrastructure.

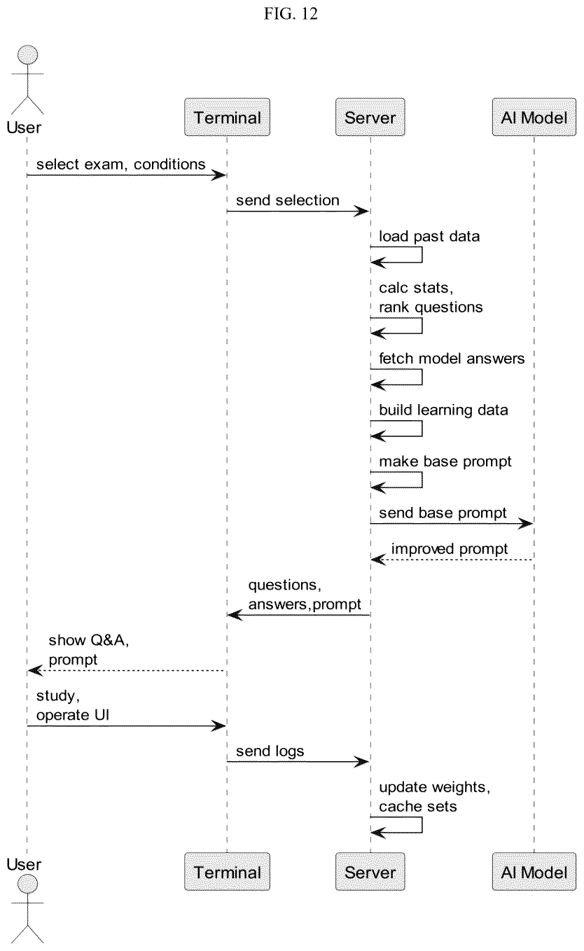

The following describes the processing flow using FIG. 12.

### Step 1:

Server provides an evaluation selection interface to Terminal.

Server prepares HTML, style data, and script code that include a list of evaluation targets (for example, exam categories and subjects) and possible evaluation conditions (for example, year range and difficulty level) as selectable items.

Input: configuration data describing available evaluation targets and evaluation conditions stored in a structured information storage area.

Processing: Server reads the configuration data from a database table, converts each record into option elements, and embeds these elements into a template page. Server then transmits the generated page to Terminal over a network protocol.

Output: a rendered selection screen on Terminal that displays evaluation targets and evaluation conditions in selectable UI components such as drop-down lists, radio buttons, or checkboxes.

### Step 2:

User selects an evaluation target and evaluation conditions on Terminal.

User operates input components on Terminal, such as tapping a subject name, choosing a year range (for example, “past 10 years”), and selecting a difficulty level.

Input: displayed UI elements and internal option values provided by Server in Step 1.

Processing: Terminal captures the user's selections, converts the selected items into machine-processable identification information (for example, an evaluation ID and numeric parameters), and bundles them into a request data structure.

Output: a request payload containing evaluation target identification information and evaluation condition information that Terminal is ready to transmit to Server.

### Step 3:

Terminal transmits the user's selection to Server.

Terminal sends, over a communication interface, the request payload to a predefined endpoint on Server.

Input: evaluation target identification information (for example, evaluation ID), evaluation condition information (for example, year range and difficulty level), and user identification information if available.

Processing: Terminal encodes the payload in a structured format, attaches transmission headers, and issues the network request. Server receives the request, decodes the payload, and validates the parameters.

Output: on Terminal, a confirmation that the request has been sent; on Server, an internal representation of the user's selected evaluation target and evaluation conditions.

### Step 4:

Server retrieves past evaluation result information and past question information.

Server accesses the structured information storage area, such as a relational database, and obtains data records that match the received evaluation target and conditions.

Input: evaluation target identification information and evaluation condition information received in Step 3.

Processing: Server constructs query conditions (for example, evaluation ID equals the selected ID and year is within the specified range), executes queries on tables storing past evaluation results and past question information, and collects all matching rows. Server then loads these rows into in-memory data structures such as arrays or data frames.

Output: a first in-memory dataset representing past evaluation result information and a second in-memory dataset representing past question information, both filtered according to the user's selection.

### Step 5:

Server combines the retrieved information and computes statistical indicators.

Server associates each question with aggregated outcome statistics based on past evaluation results.

Input: the past evaluation result dataset and the past question dataset obtained in Step 4.

Processing: Server performs join operations on the two datasets using keys such as question identifiers and evaluation session identifiers. Server then iterates over the combined records to compute, for each question, values such as occurrence frequency, correct answer rate, score contribution, and correlation with pass or fail. Server may normalize these values and store them as additional fields.

Output: an enriched question dataset in which each question record contains statistical indicators derived from past evaluation results.

### Step 6:

Server calculates importance scores and extracts questions that contribute to a pass standard.

Server evaluates which questions have the strongest statistical association with achieving a passing score.

Input: the enriched question dataset containing statistical indicators from Step 5.

Processing: Server applies a scoring function that multiplies each statistical indicator by a weighting coefficient and sums the results to compute an importance score for each question.

Server sorts the questions by their importance scores and selects those whose scores exceed a threshold or rank within a specified top range.

Output: a subset of question records identified as questions that contribute to a pass standard, along with their computed importance scores.

### Step 7:

Server acquires model answer information for the extracted questions and constructs a learning information structure.

Server associates each selected question with one or more reference answers and explanations.

Input: identifiers of questions that contribute to a pass standard from Step 6.

Processing: Server queries a model answer table in the structured information storage area using the question identifiers, retrieves corresponding model answer texts and metadata, and merges these with the selected question records. Server then organizes the combined data into a hierarchical or structured representation that pairs each question with its model answer, topic, difficulty, and statistics.

Output: a structured learning information object containing key questions and their associated model answers and attributes.

### Step 8:

Server generates a base prompt sentence for a generative AI model.

Server composes a natural-language instruction that reflects the selected evaluation target and conditions.

Input: evaluation target identification information, evaluation condition information, and optionally summary statistics of the selected questions from Step 6.

Processing: Server selects an appropriate natural-language instruction template, replaces placeholder tokens with attribute information such as exam name, subject, year range, and user proficiency level, and concatenates the resulting strings to form a prompt sentence.

Output: a base prompt sentence intended to be supplied to a generative AI model, for example:

“For the national university entrance examination in English, identify questions that define the passing line over the past 10 years and provide step-by-step model answers with explanations understandable for high school students.”

### Step 9:

Server refines the prompt sentence using a generative AI model.

Server interacts with the model to obtain a more precise and effective prompt.

Input: the base prompt sentence generated in Step 8 and a refinement instruction.

Processing: Server transmits the base prompt sentence to the generative AI model through an input/output interface, together with an instruction specifying that the model should improve clarity and effectiveness for exam preparation. The generative AI model processes the input sequence using its internal neural network layers and returns a modified text. Server receives the output, checks that the content is consistent with the original intent, and adopts it as an improved prompt sentence.

Output: an improved prompt sentence that is optimized for guiding further content generation, for example:

“Identify the questions that define the passing line in the national university entrance examination in English over the last 10 years, and present each question with a clear, step-by-step model answer.”

### Step 10:

Server packages learning information and the improved prompt sentence and transmits them to Terminal.

Server prepares data that Terminal can render for the user's learning session.

Input: the structured learning information object from Step 7 and the improved prompt sentence from Step 9.

Processing: Server encodes the combined information into a transmission format, attaches identifiers and metadata such as evaluation ID and time of generation, and sends the encoded data through a communication interface to Terminal. Server may also apply compression or batching to reduce communication load.

Output: a transmitted data payload that includes selected questions, associated model answers, and the improved prompt sentence, delivered to Terminal.

### Step 11:

Terminal receives, parses, and displays the learning presentation information.

Terminal renders the questions, model answers, and prompt sentence for interactive use by User.

Input: the transmitted data payload containing learning information and the improved prompt sentence from Step 10.

Processing: Terminal decodes the payload, constructs internal objects corresponding to questions and answers, and generates user interface components such as question lists, answer panels, and a text field displaying the improved prompt sentence. Terminal arranges these components on the screen and handles resizing, scrolling, and navigation.

Output: a displayed learning interface in which User can view key questions, read model answers, and see the improved prompt sentence for potential use with an external generative AI model.

### Step 12:

User performs learning operations and optional prompt reuse.

User interacts with the displayed information to study and optionally to invoke external AI services.

Input: displayed questions, model answers, and improved prompt sentence from Step 11.

Processing: User reads and attempts questions, reveals model answers, marks items as difficult or mastered, and may copy the improved prompt sentence and paste it into an external generative AI tool to request additional explanations or practice questions.

Output: user interactions performed on Terminal, including selections, markings, and any modified prompt sentences used outside the system.

### Step 13:

Terminal records user behavior and sends history information to Server.

Terminal captures interaction patterns that are useful for adaptive processing.

Input: user operations and viewing activity from Step 12, such as clicks, taps, time spent on each question, and difficulty markings.

Processing: Terminal logs each event with associated identifiers and timestamps, aggregates events over a session or time window, and forms browsing history information and operation history information. Terminal then transmits this history data to Server via the communication interface.

Output: a history payload containing structured records of user behavior associated with questions and evaluation targets.

### Step 14:

Server updates extraction conditions and weighting coefficients based on user history.

Server adapts its internal selection logic to reflect actual learning behavior.

Input: browsing history information and operation history information received from Terminal in Step 13, together with existing extraction conditions and weighting coefficients.

Processing: Server analyzes the history data to compute behavior-based metrics, such as frequencies of revisiting questions, average viewing time per question, and distributions of difficulty markings. Server updates weighting coefficients in the importance scoring function to increase emphasis on questions frequently revisited by successful users or often marked as difficult. Server may also adjust thresholds or filter conditions used to define questions that contribute to a pass standard.

Output: revised extraction conditions and updated weighting coefficients stored in the structured information storage area and applied in subsequent executions of Steps 5 and 6.

### Step 15:

Server optionally precomputes and caches updated key question sets for future sessions.

Server prepares optimized data for faster response to subsequent user requests.

Input: updated extraction conditions and weighting coefficients from Step 14, along with the stored evaluation data.

Processing: Server re-executes the importance score computation and selection logic for frequently used evaluation targets under the new parameters. Server stores the resulting sets of key questions and their statistics in a cache region, indexed by evaluation target and condition descriptors.

Output: precomputed key question sets and associated metadata that allow Server to respond more quickly and efficiently when the same or similar evaluation selections are requested by Terminal in future sessions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented examination support systems generally focus on static retrieval and display of past questions and model answers stored in a data repository. Such systems typically present the same question sets and study plans to a broad range of users, irrespective of differences in examination type, temporal evolution of question trends, or individual user behavior. As a result, these systems fail to fully exploit the available performance data and task data in a structured manner, and do not provide a dynamically optimized learning environment tailored to a specific evaluation target and to a specific user.

In particular, in many known systems, server-side processing is limited to simple filtering and sorting of stored data, without performing fine-grained statistical analysis of past performance information in combination with past task information, and without adjusting analysis methods based on the characteristics of a selected evaluation target. This leads to a technical problem in that the server cannot automatically extract high-importance learning target areas or prioritize task types that are most relevant for improving success probability for a given examination category.

Furthermore, existing systems that incorporate a generative artificial intelligence model typically treat user prompts in isolation, and provide responses that are not context-aware with respect to server-side analysis results or the user's ongoing learning plan. The generative model is often invoked with minimal or ad-hoc context, resulting in responses that may be unrelated to the actual question trends or success criteria of the selected evaluation target. This imposes a technical limitation on the usefulness of generative content, because the server does not systematically construct and maintain structured context information for guiding the generative artificial intelligence model.

Additionally, conventional architectures generally lack a feedback loop in which the server logs detailed interaction history, including prompt sentences and generated responses, and uses such history to adapt future analysis, learning plans, and generative model context.

Without this feedback mechanism, the server cannot incrementally refine high-importance learning target areas or task types based on actual user behavior and performance, and cannot adjust the difficulty or focus of subsequently generated responses in a technically robust manner.

In summary, there is a need for a computer-implemented system and server-side control method that (i) perform structured acquisition and statistical analysis of past performance information and past task information for a selected evaluation target, (ii) generate and update learning plan information and learning content information in a dynamic, context-sensitive manner, and (iii) integrate a generative artificial intelligence model using rich, server-constructed context information and logged interaction history, thereby improving the operation of the computer system itself as an adaptive, examination-oriented learning platform.

The specific processing by the specific processing unit 290 of the data processing device 12 in Example 2 is realized by the following means.

The present invention provides a server comprising a processor and an information storage apparatus, the processor being configured to provide an interface for allowing a user, via a user information processing apparatus, to select an evaluation target, to acquire, from the information storage apparatus, past performance information and past task information corresponding to the selected evaluation target, to apply numerical and statistical processing to the acquired information to extract indicator information representing success criteria and question trend information specific to the evaluation target, to identify, based on the extracted indicator information and question trend information, high-importance learning target areas and task types to be preferentially addressed, to generate learning plan information by dividing a learning period into a plurality of learning units based on the identified learning target areas and task types and user-specific learning time information and evaluation execution date information, to generate learning content information by extracting, from the information storage apparatus, task information and model answer information corresponding to each learning unit and formatting the extracted information for presentation to the user information processing apparatus, to construct input data for a generative artificial intelligence model based on a prompt sentence including a free-form inquiry text received from the user information processing apparatus and context information including at least the indicator information, the question trend information, and the learning plan information relating to the selected evaluation target, to cause the generative artificial intelligence model to generate a response text using the constructed input data, to output the generated response text in a predetermined display format as additional explanation information or additional task information corresponding to the inquiry text, to record, in the information storage apparatus as history information, each prompt sentence and each response text together with associated evaluation targets and learning target areas, and to update, based on the recorded history information, conditions for identifying the high-importance learning target areas and task types so as to dynamically change the subsequently generated learning plan information and the context information supplied to the generative artificial intelligence model. This enables the computer system to perform improved, context-aware analysis and adaptation at the server side, thereby dynamically optimizing examination-oriented learning plans and generative responses, and enhancing the technical functionality and efficiency of the computer-implemented learning environment.

The term “evaluation target” refers to a category of assessment, such as an examination, a test, or another structured evaluation, for which performance information and task information are stored and analyzed by the system.

The term “user information processing apparatus” refers to an information processing device operated by a user, such as a general-purpose computing device or a communication terminal, that performs information display and information input and communicates with the server.

The term “information storage apparatus” refers to one or more storage resources, such as a non-transitory computer-readable storage medium or a storage subsystem, that store past performance information, past task information, model answer information, configuration information, and history information used by the server.

The term “past performance information” refers to data records representing results of prior executions of an evaluation target, including at least scores, pass or fail indicators, dates, and optional metadata associated with examinees or sessions.

The term “past task information” refers to data records representing previously used tasks in an evaluation target, including at least question texts, task types, topics, difficulty levels, and presentation dates.

The term “indicator information” refers to derived data representing success criteria obtained by processing past performance information and past task information, including at least thresholds, distributions, and statistical measures indicative of passing conditions or high achievement.

The term “question trend information” refers to derived data characterizing temporal or categorical patterns in past task information, including at least topic frequencies, difficulty distributions, and occurrence trends of task types over time.

The term “learning target area” refers to a conceptual domain or subject segment identified by the system, such as a topic, subtopic, or competence area, for which the user is recommended to perform learning activities.

The term “task type” refers to a classification category of a task, such as a multiple-choice question, a descriptive question, a calculation problem, or another structured exercise format.

The term “learning period” refers to a time interval, determined with reference to a current time and an evaluation execution date, during which the user is expected to carry out learning activities for a selected evaluation target.

The term “learning unit” refers to a subdivision of the learning period, such as a session, day, or block, to which the system assigns specific learning target areas, task types, problem quantities, and difficulty levels.

The term “learning plan information” refers to structured data defining, for each learning unit, at least one learning target area, at least one task type, a number of problems, a difficulty level, and optionally timing or scheduling information for the user.

The term “learning content information” refers to data generated by the server for presentation to the user, including at least specific task information and associated model answer information arranged according to the learning plan information.

The term “task information” refers to concrete task data, such as question statements, answer options, required outputs, or input conditions, which the user is to solve or study.

The term “model answer information” refers to reference answer data associated with task information, including at least correct answers, example solutions, or explanatory solutions that demonstrate an expected or exemplary response.

The term “numerical processing means” refers to one or more computational processes executed by the processor to perform numerical operations on data, such as aggregations, weightings, or transformations of performance and task records.

The term “statistical processing means” refers to one or more computational processes executed by the processor to perform statistical analysis, such as calculating distributions, averages, variances, quantiles, correlations, or other statistical indicators.

The term “prompt sentence” refers to an input text, often in free-form natural language, provided by the user through the user information processing apparatus to request information, explanations, or additional tasks from the system.

The term “generative artificial intelligence model” refers to a machine-learned model, such as a language model, that receives input data including at least a prompt sentence and context information and outputs a generated response text in natural language or another representational format.

The term “response text” refers to an output generated by the generative artificial intelligence model in response to input data, including at least explanations, additional task descriptions, or other information intended for presentation to the user.

The term “context information” refers to structured or semi-structured data that the server supplies together with a prompt sentence to the generative artificial intelligence model, including at least indicator information, question trend information, learning plan information, and optionally user-specific or session-specific parameters.

The term “history information” refers to logged records stored in the information storage apparatus, including at least prompt sentences from the user, response texts generated by the generative artificial intelligence model, associated evaluation targets, and associated learning target areas.

The term “weighting condition” refers to a parameter or rule that specifies relative importance assigned to subsets of past performance information or past task information, such as different time periods, topics, or task types, during statistical or numerical analysis.

The term “target period condition” refers to a parameter or rule that restricts the time range of past performance information or past task information to be considered during analysis, such as limiting data to a specified number of recent years or sessions.

The term “task format condition” refers to a parameter or rule that specifies which task formats or task types are to be included or emphasized during analysis, such as selecting only written tasks or only objective-choice tasks.

The term “analysis conditions” refers to a set of conditions, including at least a weighting condition, a target period condition, and a task format condition, that determine how the numerical processing means and the statistical processing means operate on past performance information and past task information.

The term “operation history information” refers to data representing the user's interactions with learning content, including at least task selection, answer submission, navigation events, and other operation logs during learning units.

The term “correct-answer status information” refers to data representing correctness or incorrectness of the user's responses to task information, including at least binary correctness flags, partial scores, or error categories.

The term “difficulty scale” refers to a computed measure that indicates the relative difficulty level of tasks or learning units for a particular user, derived from at least operation history information and correct-answer status information.

The term “achievement scale” refers to a computed measure that indicates the degree of progress or mastery of a user with respect to one or more learning target areas, derived from at least operation history information and correct-answer status information.

The term “predetermined display format” refers to a defined layout or representation, such as a text format, markup structure, or graphical arrangement, used by the server to render response texts, learning plan information, or learning content information on a user information processing apparatus.

In one embodiment, a server includes at least one processor, a main memory, a non-transitory storage device, and a communication interface connected to a communication network. The server executes a program stored in the storage device to implement the functions described below. A terminal includes at least one processor, a display device, an input device, a memory, and a communication interface. A user operates the terminal to interact with the server. The server and the terminal communicate using a network protocol such as HTTPS over a packet-switched network.

The server stores, in the storage device, an information storage apparatus logically realized by a relational database management system, for example a database engine such as MySQL.

The server stores in tables of the database engine past performance information, past task information, model answer information, configuration information, and history information.

The server uses a database driver, for example a structured query interface compatible with the database engine, to perform read and write operations by executing parameterized queries.

The server stores past performance information in a performance table having at least fields for an evaluation target identifier, a session identifier, a candidate identifier, a score, a pass/fail flag, an evaluation date, and optional metadata. The server stores past task information in a task table having at least fields for a task identifier, an evaluation target identifier, a topic identifier, a difficulty level, a task type, a task text, and a presentation date.

The server stores model answer information in an answer table having at least fields for a task identifier, an answer text, and an explanation text. The server stores configuration information in a configuration table or in a structured document (for example, a JSON file) having fields such as a weighting condition, a target period condition, a task format condition, topic-specific coefficients, and parameters for analysis and scheduling. The server stores history information in a history table having at least fields for a user identifier, an evaluation target identifier, a learning target area identifier, a prompt sentence, a response text, a timestamp, and optional difficulty and achievement measures.

The server uses a software execution environment, such as an operating system and a runtime environment for a high-level programming language (for example, Python), and a data analysis library (for example, a numerical computation library and a tabular data library) to perform numerical processing and statistical processing. The server loads query results from the database engine into in-memory data structures, such as data frames, that internally represent tables as arrays of records with typed columns. The server applies aggregation operators, grouping operators, and statistical functions to these data structures to compute indicator information representing success criteria and question trend information.

The server analyzes past performance information by computing, for each evaluation target identifier, distributions of scores, quantiles (for example, 0.5, 0.8, 0.9 quantiles), average scores, variance values, and pass rates. The server computes indicator information representing success criteria, such as a minimum passing line derived from historical pass/fail data, a typical high-score range corresponding to a specified upper quantile, and a stability index derived from yearly variance. The server stores such indicator information in an in-memory cache associated with the evaluation target identifier and optionally persists the information into an aggregate table.

The server analyzes past task information by performing topic-wise and year-wise frequency analysis. The server groups the task data by topic identifier and presentation date (for example, by year), counts the number of tasks per group, and normalizes the counts to obtain relative frequencies per topic and year. The server further applies text processing methods using a natural language processing library to tokenize task texts, remove stop words, and compute term frequency metrics. The server uses these metrics to adjust or refine topic identifiers, for example by merging low-frequency topics or splitting heterogeneous topics.

The server produces question trend information such as “topic A has increased in frequency over the past three years,” “task type B occurs predominantly at difficulty level C,” and “combinations of topic D and topic E are likely to appear together.”

The server identifies high-importance learning target areas and task types by combining indicator information and question trend information in a structured calculation. In one embodiment, the server assigns, to each topic identifier and task type, an importance score computed as a weighted sum of (i) normalized topic frequency in recent periods, (ii) correlation coefficients between topic coverage and passing scores, and (iii) difficulty-adjusted contributions to high-score ranges. The server may use a logistic regression algorithm implemented in a machine learning library to learn a mapping from feature vectors (for example, coverage of each topic and difficulty band in a user's historical attempt) to a binary pass/fail outcome. The server interprets regression weights as importance contributions of each topic and difficulty band. The server defines high-importance learning target areas as those topics whose importance scores exceed a threshold or belong to a top percentile. The server defines preferred task types as those most closely associated with transitions from near-pass to pass conditions. This computation is not a mere automation of human analysis, because the server executes numerical optimization and correlation estimation across large-scale historic datasets that are not tractable for human operators, and the server reuses the learned parameters algorithmically to adapt future plans and generative model inputs.

The server generates learning plan information by computing, for each user and evaluation target, a mapping from a learning period to a set of learning units. The server obtains a current time from a system clock and obtains an evaluation execution date and available learning time per day or week from user input stored in the storage device. The server divides the interval between the current time and the evaluation execution date into discrete learning units (for example, daily or session-based units) using scheduling parameters. The server allocates high-importance learning target areas to earlier learning units with finer granularity and allocates lower-importance areas to later or less frequent units. The server uses a scheduling algorithm that considers the total number of tasks needed per topic and difficulty level, the available time, and a maximum number of tasks per unit to avoid excessive workload. The server stores learning plan information as a structured record for each learning unit, including at least a unit identifier, a date or order index, one or more learning target area identifiers, one or more task types, a planned number of tasks per type, and a difficulty range.

The server generates learning content information by retrieving, for each learning unit, a subset of task information and model answer information that match the assigned learning target areas, task types, and difficulty levels. The server selects tasks using sampling strategies such as stratified random sampling within each topic-difficulty bucket to ensure coverage of different subtypes and avoid repetition. The server retrieves corresponding model answer information and constructs composite objects combining task statements and solution texts. The server encodes these composite objects into a representation suitable for transmission (for example, a serialized structure with fields for task text, answer text, explanation text, topic identifiers, and difficulty levels) and sends them to the terminal.

The terminal displays the learning content to the user via a graphical user interface. The terminal shows task texts, input fields for user answers, and controls for revealing model answers and explanations. The terminal collects operation history information, such as which tasks were started, which answers were submitted, how long each task took, which explanations were viewed, and which tasks were skipped. The terminal sends operation history information and correct-answer status information to the server in structured form, for example as HTTP requests with payloads indicating task identifiers, user responses, correctness flags, and timestamps.

The server computes a difficulty scale and an achievement scale for each user by processing operation history information and correct-answer status information. The server aggregates, per learning target area and difficulty band, metrics such as proportion of correct answers, time per task, number of reattempts, and number of explanation views. The server uses these metrics to calculate a difficulty scale, for example as an estimated ability parameter in an item-response-theory-like model, and an achievement scale, for example as a normalized mastery score that increases when the user consistently answers tasks correctly with low latency. The server stores these scales as part of history information and updates them as new data arrive. The server uses the updated scales to refine subsequent allocations in learning plan information and to compute context information supplied to a generative AI model.

The server uses a generative AI model implemented as a neural network of the transformer architecture. In one embodiment, the generative AI model includes multiple layers of self-attention and feedforward sublayers, with learned weight matrices and bias parameters. The model receives tokenized text sequences as input and outputs token probability distributions for generating response texts. The model is pre-trained on large-scale text corpora using a language-modeling objective function such as cross-entropy loss and may be fine-tuned on domain-specific exam data. The server stores the model parameters on a dedicated compute resource or accesses them through an inference server.

The server transforms a prompt sentence and context information into an input sequence for the generative AI model. The server tokenizes each text segment (for example, the prompt sentence, indicator information summary, question trend summary, current learning unit description, and user-specific difficulty and achievement scales) using a tokenizer consistent with the model's vocabulary. The server constructs a sequence of tokens with special delimiters and role indicators, such as tokens marking system instructions, context blocks, and user inquiries. The server includes structured tags in the input, for example indicating evaluation target identifiers, topic identifiers, difficulty levels, and desired output types (e.g., explanation, new problem, step-by-step solution). By embedding these structure-aware tokens, the server controls the generative AI model's internal attention patterns so that attention layers emphasize exam-specific and user-specific information instead of generic text knowledge.

The server configures inference parameters such as a temperature parameter, a top-k or top-p sampling parameter, and a maximum token length to control the diversity and length of generated response texts. The server executes forward passes of the generative AI model using computation hardware such as a central processing unit or a graphics processing unit.

The server obtains output token sequences and reconstructs them into response texts. The server applies post-processing such as removal of incomplete sentences at boundaries, normalization of mathematical expressions, and insertion of line breaks compatible with terminal display.

The server records each prompt sentence and each corresponding response text, along with metadata such as evaluation target identifiers, learning target area identifiers, difficulty scales, and achievement scales, in the history table of the information storage apparatus. The server uses this history information to update conditions for identifying high-importance learning target areas and task types. For example, if a given topic area repeatedly requires additional explanations and shows low achievement scales across multiple users, the server increases its weight in importance scoring and schedules more tasks in that topic earlier in learning plans. If a particular kind of task request appears frequently in prompt sentences (for example, repeated requests for step-by-step solutions in calculus), the server adjusts learning content selection and model context to emphasize that form of content. The server thereby implements a dynamic feedback loop that modifies analysis and planning algorithms over time in response to real usage patterns.

The server thereby improves computer technology in multiple respects. First, the server reduces computation load at runtime by precomputing and caching indicator information and question trend information and by structuring the database schema and analytics flow so that incremental updates are performed on limited subsets of data rather than recomputing all statistics. This design lowers server-side CPU utilization and reduces response latency for user queries. Second, the server improves precision of exam-specific content generation by using learned importance scores and structured context tokens to direct the generative AI model towards topics and difficulty levels that match the specific evaluation target and the user's current mastery. This reduces the occurrence of irrelevant or off-topic generated content, which in turn reduces network bandwidth consumption and client-side rendering overhead. Third, the server enhances data management by using normalized relational tables and indexed fields for evaluation target identifiers, topic identifiers, and difficulty levels, enabling efficient retrieval and aggregation operations even when the dataset grows large.

The server also departs from a mere automation of human study planning or tutoring. Instead of simply digitizing a fixed rulebook, the server computes topics' importance and user difficulty based on large-scale statistical patterns and machine-learned parameters, using non-obvious feature combinations and continuous updates in response to history information. The server uses logistic regression or similar models on explicit numeric features (for example, frequency of each topic in high-score sessions, difficulty band distributions, temporal trend gradients) and uses the model's learned weights as algorithmic guidance. These weights represent internal machine-learned parameters stored in the server's memory and are applied at inference time to evaluate candidate allocations or content suggestions. Human tutors cannot manually replicate such calculations at scale or update them in real time for thousands of users; the server's algorithmic structure and data flows provide a technical solution that exploits hardware resources for computation and storage in a way that changes system behavior.

The server can employ different variants of the generative AI model. In one variant, the server uses a single large-scale transformer model serving all evaluation targets, and uses exam-specific context tokens and configuration parameters to specialize its behavior. In another variant, the server uses multiple smaller models fine-tuned for different exam families and selects an appropriate model based on the evaluation target identifier. In yet another variant, the server uses an ensemble approach, where a first model generates candidate responses and a second model scores or filters them based on exam-specific criteria, such as inclusion of required concepts or adherence to length limits. These variants all rely on explicit control of model input and parameters by the server and on structured feedback from history information to improve the technical performance of the models in the system context.

The server can handle variations in the information storage apparatus as well. In one embodiment, the server uses a relational database engine for all persistent data and an in-memory key-value store as a cache for frequently used aggregates and per-user state, further reducing latency and disk access. In another embodiment, the server uses a column-oriented storage format for performance and task data, enabling faster aggregation and scanning when computing indicator information and question trend information. In each case, the server uses explicit indexing on evaluation target identifiers, topic identifiers, and time fields to support efficient range queries and join operations.

The terminal can be realized as a general-purpose computing device (such as a personal computer), a mobile communication device (such as a smartphone), or a dedicated learning appliance. The terminal executes a client application or a web browser that renders user interface pages transmitted from the server. The terminal displays interactive components that allow the user to select evaluation targets, input prompt sentences, start learning units, submit answers, and view generated responses. The terminal collects local interaction events, compresses them if necessary, and transmits them to the server, which uses them to drive its internal analytics and generative context formation.

In one concrete example, the user selects an examination related to calculus. The user later enters the following prompt sentence in the terminal:

“Please give me three new practice questions on differentiation and integration at the same level as this exam and show step-by-step solutions.”

The terminal sends this prompt sentence, together with the current evaluation target identifier and learning unit identifier, to the server. The server embeds, in the context information, indicator information that the passing line is at a given score and that high-scoring candidates typically solve medium-to high-difficulty calculus tasks efficiently, and embeds question trend information indicating that questions on definite integrals and applications of derivatives have increased in recent years. The server also embeds the user's current difficulty and achievement scales, indicating that the user performs well on basic differentiation but less well on definite integrals. The server constructs a sequence of tokens encoding all of this information and supplies it to the generative AI model. The resulting response text includes three exam-style questions, each annotated with detailed step-by-step solutions that allocate more explanatory detail to definite integrals than to basic derivative rules. The server's structured context construction and parameterized inference thus cause the generative AI model to produce task sets and explanations that are adapted both to the exam and to the user's current level, improving learning efficiency and reducing unnecessary content generation.

In another example, the user enters the prompt sentence:

“Explain the concept of definite integrals using an easy example.”

The server again constructs context information that includes the exam-specific trend of recent focus on definite integrals, the user's low achievement scale on that topic, and the current learning unit's schedule. The generative AI model receives this encoded context, and, guided by the server's design of special tokens indicating “easy explanation,” “definite integral,” and “current exam type,” produces a simplified conceptual explanation and a low-difficulty example problem suitable for the user. This interaction shows that the generative AI model is not simply a black-box answering generic questions, but an integrated component of a server-controlled pipeline with structured inputs, learned parameters, and adaptive feedback that collectively improve the operation of the computer-based learning system.

Through these embodiments and variants, the server, the terminal, and the generative AI model cooperate to implement an examination-oriented learning environment in which data structures, processing flows, and neural-network-based text generation are tightly integrated.

The system thereby provides technical improvements in processing speed, adaptation precision, resource utilization, and content relevance, going beyond simple computerization of human study support and constituting an improvement to computer technology itself.

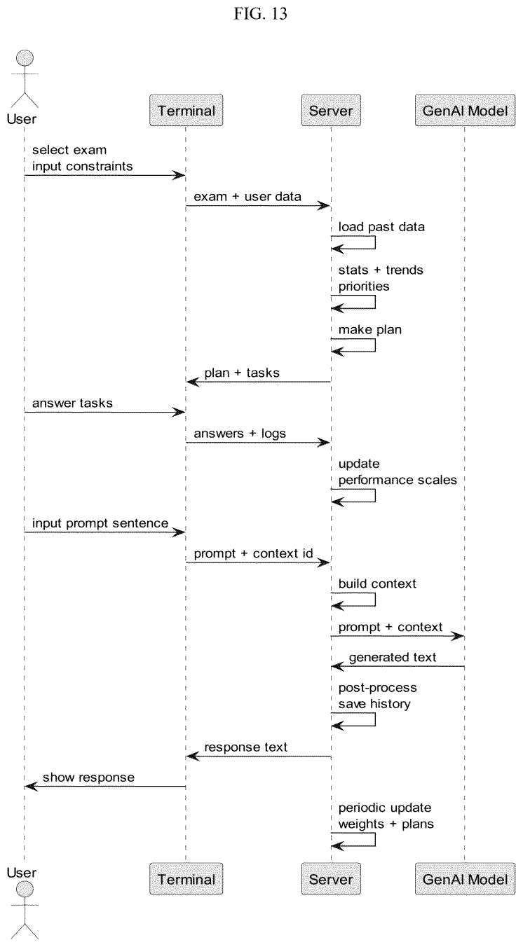

The following describes the processing flow using FIG. 13.

### Step 1:

User operates the terminal to access the system and select an evaluation target.

User views, on the terminal display, a list of evaluation targets (for example, examination categories) and selects one item using an input device such as a keyboard, mouse, or touch panel.

Input: a user identifier and a selected evaluation target identifier entered via the terminal interface.

Output: a request message including the user identifier and the selected evaluation target identifier transmitted from the terminal to the server.

### Step 2:

Terminal sends the selection information to the server.

Terminal encapsulates the user identifier and the selected evaluation target identifier into a structured message, such as an HTTPS POST request with a payload including key-value pairs, and transmits the message to a designated server endpoint.

Input: user identifier and evaluation target identifier obtained from the user interface.

Output: a network packet containing the structured message delivered to the server.

### Step 3:

Server receives the selection information and initializes analysis context.

Server parses the incoming request, validates the user identifier, and stores the evaluation target identifier in a session data structure in main memory or in a session table in the storage apparatus.

Input: network packet containing the user identifier and evaluation target identifier.

Output: a session record including the evaluation target identifier, and an internal context object that will be used in subsequent analysis and planning.

### Step 4:

Server retrieves past performance information and past task information from the information storage apparatus.

Server issues parameterized database queries to the relational database engine, filtering records in performance and task tables by the evaluation target identifier stored in the session.

Input: evaluation target identifier from the session context.

Output: two in-memory datasets, one containing past performance records (scores, pass/fail flags, dates) and one containing past task records (topics, difficulty, task types, task texts, dates).

### Step 5:

Server performs numerical and statistical processing on past performance information.

Server loads performance records into a tabular data structure and computes distributions, means, variances, and quantiles of scores, and calculates pass rates per period.

Input: dataset of past performance records.

Output: indicator information representing success criteria, including at least a derived passing score threshold, high-score boundaries, and stability metrics, stored in an internal indicator data structure.

### Step 6:

Server analyzes past task information to derive question trend information.

Server groups task records by topic, difficulty level, task type, and time period, counts occurrences, normalizes counts to relative frequencies, and optionally processes task texts with a natural language processing library to refine topic labels.

Input: dataset of past task records.

Output: question trend information summarizing topic frequencies, difficulty distributions, and temporal trends, stored in an internal trend data structure.

### Step 7:

Server identifies high-importance learning target areas and task types.

Server combines indicator information and question trend information by computing importance scores for each topic and task type using weighted sums or a machine learning model, and ranks them according to contributions to passing outcomes.

Input: indicator information and question trend information.

Output: a prioritized list of learning target areas and task types, stored as importance-ranked records in memory or in a configuration table.

### Step 8:

User inputs learning constraints via the terminal.

User specifies, on a configuration screen, the planned evaluation execution date and available learning time per day or week, and submits this information.

Input: evaluation execution date and learning time parameters entered by the user.

Output: a configuration message transmitted from the terminal to the server containing the user's learning constraints.

### Step 9:

Server generates learning plan information based on priorities and constraints.

Server calculates the learning period from the current time to the evaluation execution date, divides the period into discrete learning units (for example, daily units), and allocates high-importance learning target areas and task types across units considering the available learning time and maximum problem counts.

Input: prioritized list of learning target areas and task types, evaluation execution date, and learning time parameters.

Output: learning plan information comprising multiple learning units, each with assigned topics, task types, problem quantities, and difficulty ranges, stored in a plan table and cached for quick access.

### Step 10:

Server selects learning content for the initial learning unit.

Server filters task records according to the first learning unit's assigned learning target areas, task types, and difficulty ranges, and samples a set of concrete tasks and associated model answers.

Input: learning plan information for the initial learning unit and the global task and answer datasets.

Output: learning content information for the initial unit, including selected task texts, model answers, and explanations, formatted for transmission.

### Step 11:

Terminal requests and receives the learning content for display.

Terminal sends a request including a learning unit identifier to the server, receives the corresponding learning content information, and prepares it for rendering.

Input: learning unit identifier selected by the user.

Output: received learning content information in a structured format stored temporarily in terminal memory.

### Step 12:

Terminal displays tasks and captures user interactions.

Terminal renders each task text and provides input fields and controls for answer submission, navigation, and model answer display, and records user interactions with timestamps.

Input: learning content information for the current learning unit.

Output: operation history information and user answer submissions, buffered locally and periodically transmitted to the server.

### Step 13:

Server evaluates user responses and updates performance-related measures.

Server receives user answers and compares them with model answers, sets correctness flags, computes response times from timestamps, and aggregates these data per learning target area and difficulty band.

Input: user answer submissions and associated operation history information.

Output: correct-answer status information and aggregated statistics per topic and difficulty, stored as interim performance data.

### Step 14:

Server computes a difficulty scale and an achievement scale for the user.

Server processes the per-topic statistics to estimate the user's ability and mastery levels, for example by fitting or updating parameters in an item-response or similar model, and derives numeric difficulty and achievement scales for each learning target area.

Input: aggregated statistics derived from correct-answer status information and operation history information.

Output: updated difficulty scale and achievement scale values for the user, stored in the history table and an in-memory user profile.

### Step 15:

User enters a prompt sentence requesting additional explanation or new tasks.

User types, in a free-form text input on the terminal, a prompt sentence such as “Please give me three new practice questions on differentiation and integration at the same level as this exam and show step-by-step solutions.” and sends it.

Input: natural-language prompt sentence entered by the user.

Output: a generative query message containing the prompt sentence and context identifiers transmitted from the terminal to the server.

### Step 16:

Server constructs context information for the generative AI model.

Server retrieves indicator information, question trend information, current learning unit details, and the user's difficulty and achievement scales, and combines them into a structured context representation associated with the prompt sentence.

Input: prompt sentence, evaluation target identifier, current learning unit identifier, indicator information, question trend information, and user-specific scales.

Output: context information object containing exam-specific, topic-specific, and user-specific parameters to be supplied along with the prompt sentence.

### Step 17:

Server prepares and submits input data to the generative AI model.

Server tokenizes the prompt sentence and context information according to the vocabulary of the generative AI model, assembles a sequence of tokens with special markers indicating roles and sections, and calls the generative AI model with inference parameters such as temperature and maximum length.

Input: tokenized prompt sentence and tokenized context information, plus inference parameter settings.

Output: model input data in the form of encoded token sequences submitted to the generative AI model, and a generated token sequence representing a response text returned by the model.

### Step 18:

Server post-processes the generated response text.

Server decodes the token sequence into human-readable text, checks the output for length and formatting, normalizes mathematical expressions, and optionally adds annotations such as topic labels and difficulty indications based on the embedded context.

Input: generated token sequence from the generative AI model.

Output: a finalized response text suitable for display, packaged as additional explanation information or additional task information.

### Step 19:

Server records history information for the interaction.

Server stores, in the history table of the information storage apparatus, a record associating the user identifier, evaluation target identifier, learning target area identifiers, the prompt sentence, the generated response text, and current difficulty and achievement scales.

Input: prompt sentence, response text, and current context metadata.

Output: a history record appended to the history table and available for future analysis and adaptation.

### Step 20:

Terminal displays the generated response text to the user.

Terminal receives the finalized response text from the server, renders it on the display as explanations, new tasks with solutions, or both, and allows the user to scroll, expand details, or request further clarifications.

Input: response text and optional metadata received from the server.

Output: visual presentation of the generated content and updated operation history data reflecting user viewing and subsequent actions.

### Step 21:

Server updates importance conditions and learning plan information based on history.

Server periodically analyzes accumulated history information to detect topics that frequently trigger additional prompts or low achievement, adjusts weighting conditions and thresholds for high-importance learning target areas and task types, and modifies future learning plan information and context information accordingly.

Input: aggregated history information, including prompt sentences, response texts, and associated performance and topic data.

Output: updated importance conditions, revised analysis parameters, and adapted learning plan configurations for subsequent sessions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning support systems for examination preparation generally rely on static question banks and fixed learning plans that are generated offline or with only coarse rule-based logic. Such systems typically retrieve past questions and aggregate statistics (for example, average scores per subject) but do not perform fine-grained machine learning-based analysis to identify which specific questions, topics, and difficulty levels are most critical for achieving a passing outcome for a given examination. As a result, the underlying data processing pipeline in these systems does not fully exploit the available performance data, and the mapping from raw historical data to actionable learning plans remains shallow and inefficient from a computational-intelligence standpoint.

Furthermore, known systems that integrate machine learning or artificial intelligence often treat generative models as isolated components that simply answer user questions in a generic manner. These systems typically do not systematically generate and manage prompt sentences based on a rich, continuously updated context that includes trend information, success-criterion question information, dynamically evolving learning plans, and user-specific understanding and emotional state information. Because the interaction with a generative AI model is not orchestrated by a structured prompt-generation layer, the system cannot consistently produce high-quality, context-aware learning content, and the generative model is underutilized as a computational component.

In addition, most existing platforms either ignore emotional state information or process it only at a superficial user-interface level, such as displaying simple encouragement messages without feeding emotion-related signals back into the core data processing and control logic. Emotional data, if used at all, is seldom combined with detailed understanding information to drive algorithmic adaptation of question selection, difficulty progression, and learning plan restructuring. Consequently, the internal control flow of such systems does not use emotion recognition as a first-class input to the computational model, and the resulting adaptation remains coarse and non-personalized.

From a computer-technology perspective, there is therefore a need for an improved system architecture and processing method that: (i) performs integrated statistical and machine-learning-based analysis of past performance information and past question information to extract trend information and success-criterion question information; (ii) coordinates generative AI models through systematically constructed prompt sentences derived from rich context information; and (iii) combines user understanding information with emotion state information in the core adaptation loop to dynamically update learning question information and learning plan information at runtime. Without such integration, computing resources are used sub-optimally, the precision of personalization is limited, and the overall robustness and usefulness of AI-assisted examination preparation are constrained.

The specific processing by the specific processing unit 290 of the data processing device 12 in Application Example 2 is realized by the following means.

The present invention provides a server comprising a processor configured to provide an information presentation interface that allows a user to select an evaluation target; to acquire past performance information and past question information related to the selected evaluation target from an information storage device; to perform preprocessing on the past performance information and the past question information using a statistical processing method and a machine learning method to extract trend information and success-criterion question information; to generate learning plan information including a learning period, a learning order, a learning difficulty, and a learning amount based on the trend information and the success-criterion question information; to transmit learning question information and reference answer information to a user terminal based on the learning plan information and to compare user answer information acquired from the user terminal with the reference answer information to calculate understanding information; to estimate emotional state information by analyzing image information and audio information acquired from the user terminal using an emotion estimation method and to dynamically update at least one of the learning question information to be subsequently presented and the learning plan information according to the understanding information and the emotional state information; to generate and transmit a prompt sentence to a generative artificial intelligence model based on context information including at least one of the trend information, the success-criterion question information, the learning plan information, the understanding information, and the emotional state information and to obtain from the generative artificial intelligence model at least one of learning plan supplement information, question generation information, answer generation information, and feedback text information; and to integrate at least one of the learning plan supplement information, the question generation information, the answer generation information, and the feedback text information obtained from the generative artificial intelligence model with the learning plan information and a result of the calculation of the understanding information and to cause the integrated information to be presented to the user. This enables an improvement of computer-implemented learning support by realizing a tightly coupled pipeline in which statistical and machine-learning-based data analysis, emotion-aware adaptive control, and generative AI-driven content generation are orchestrated through structured prompt sentences and shared context information, thereby enhancing the precision, robustness, and efficiency of the underlying data processing and control mechanisms executed by the server.

The term “evaluation target” refers to any type of assessment object, including but not limited to an examination, a test, a certification, a course, a topic, or a skill category, that a user selects as a subject of computer-implemented learning support.

The term “information presentation interface” refers to an interface implemented by a computing device, such as a graphical user interface or a programmatic interface, that causes display or other output of information enabling the user to select an evaluation target and to receive learning-related information.

The term “information storage device” refers to any computer-readable storage medium, such as a database system, a file system, or another structured or unstructured data store, configured to store past performance information, past question information, and other learning-related data.

The term “past performance information” refers to data representing prior outcomes of users with respect to an evaluation target, including but not limited to scores, pass-fail indicators, time-to-answer values, and historical statistics associated with particular questions, topics, or difficulty levels.

The term “past question information” refers to data representing previously used questions associated with an evaluation target, including question texts, answer options, correct answers, metadata such as topic labels and difficulty levels, and any related explanatory information.

The term “statistical processing method” refers to any computational technique that applies statistical analysis, such as aggregation, averaging, variance calculation, distribution estimation, correlation calculation, or hypothesis testing, to derive numerical characteristics from past performance information and past question information.

The term “machine learning method” refers to any computational technique that uses data to train a model, including but not limited to classification, regression, clustering, dimensionality reduction, or reinforcement learning, in order to infer patterns or relationships from past performance information and past question information.

The term “trend information” refers to information derived from statistical processing or machine learning that characterizes patterns over time or across populations, such as frequently appearing topics, typical difficulty distributions, or correlations between question attributes and success outcomes for an evaluation target.

The term “success-criterion question information” refers to information that identifies and describes questions that are determined, based on analysis of past performance information and past question information, to be particularly important or critical for achieving a successful outcome, such as passing an examination or meeting a predefined performance threshold.

The term “learning plan information” refers to structured information that defines a computer-generated learning schedule, including at least a learning period, a learning order of topics or questions, a learning difficulty progression, and a learning amount such as a number of questions or study time per unit interval.

The term “learning question information” refers to information specifying one or more questions that are selected or generated for presentation to the user in accordance with the learning plan information, including question identifiers, texts, metadata, and any associated configuration for display or interaction.

The term “reference answer information” refers to information representing one or more target answers for corresponding questions, including correct answer values, model solutions, step-by-step explanations, or other answer patterns used as a reference for evaluation of user answers.

The term “user answer information” refers to information representing answers provided by the user to learning questions, including text inputs, selected options, numerical values, or other response data recorded by a user terminal and transmitted to the server.

The term “understanding information” refers to information indicating an estimated level of the user's understanding with respect to one or more questions, topics, or evaluation targets, derived by comparing user answer information with reference answer information and optionally aggregating results over multiple interactions.

The term “image information” refers to visual data captured by an image sensor of a user terminal, such as still images or video frames of a user's face or surroundings, that can be processed to infer user emotional states or engagement levels.

The term “audio information” refers to sound data captured by an audio sensor of a user terminal, such as the user's speech or other vocal expressions, that can be processed to infer user emotional states or engagement levels.

The term “emotion estimation method” refers to any computational technique that processes image information, audio information, or other sensor data to infer an emotional state of the user, such as happiness, confusion, frustration, boredom, or confidence, including but not limited to methods based on pattern recognition or machine learning.

The term “emotional state information” refers to information representing an estimated emotional condition of the user, including discrete emotion labels, continuous scores, intensity values, or time series of emotion estimations, produced by an emotion estimation method.

The term “context information” refers to aggregated information that characterizes a current or historical learning situation for a user, including at least one of trend information, success-criterion question information, learning plan information, understanding information, and emotional state information.

The term “prompt sentence” refers to a natural-language or structured text input that is generated by the processor and provided to a generative artificial intelligence model, the prompt sentence specifying instructions and context for generation of learning plan supplement information, question generation information, answer generation information, or feedback text information.

The term “generative artificial intelligence model” refers to a computational model for machine-generated content, such as a language model or multimodal model, configured to produce text or other output in response to a prompt sentence, based on patterns learned from training data.

The term “learning plan supplement information” refers to information generated by the generative artificial intelligence model that supplements or refines an existing learning plan, such as additional scheduling details, alternative topic sequences, or personalized recommendations.

The term “question generation information” refers to information generated by the generative artificial intelligence model that specifies one or more questions to be used in learning, including question texts, formats, and associated metadata, which may be newly generated or adapted based on context information.

The term “answer generation information” refers to information generated by the generative artificial intelligence model that specifies one or more answers or solution explanations for questions, including model answers, step-by-step solution descriptions, or alternative solution approaches.

The term “feedback text information” refers to natural-language feedback generated by the generative artificial intelligence model, including explanations of user errors, suggestions for improvement, motivational messages, or guidance on next learning steps.

The term “prediction model” refers to a trained machine learning model that receives question feature information and optionally other inputs, and outputs predicted values such as pass-fail indicators, importance scores, or relevance scores associated with questions.

The term “question feature information” refers to information representing attributes of questions, such as topic, difficulty level, format type, required skills, linguistic features, or other descriptors usable as input features for a machine learning model.

The term “pass-fail indicator information” refers to information indicating a pass or fail outcome for one or more users or question instances, including binary labels, probabilities of passing, or other performance indicators.

The term “importance information” refers to information that quantifies the relative contribution or significance of a question or topic to achieving a target outcome, such as passing an evaluation target, as determined by a prediction model or other analysis.

The term “relevance information” refers to information that quantifies how closely a question or topic is related to a target evaluation objective, user skill profile, or current learning context, as determined by a prediction model or other analysis.

The term “learning history information” refers to accumulated information regarding a user's past learning interactions, including at least understanding information, emotional state information, timestamps, question identifiers, and changes to learning plan information over time.

In one embodiment, a server, a terminal, and a user cooperate to implement the claimed system. The server includes at least one processor, a memory, and a network interface. The terminal includes at least one processor, a memory, a display, an image sensor such as a camera, an audio sensor such as a microphone, and a network interface. The user operates the terminal to interact with the server.

The server executes software components implemented, for example, using an application framework such as a web server framework, a data analysis library such as a numerical computation library, a machine learning library such as a general-purpose machine learning toolkit, and a deep learning library such as a tensor-based computation framework. The server further accesses one or more storage systems, such as a relational database management system (for example, implemented with tables and indexes), and a file storage system for models and logs.

The server stores, in the database, past performance information and past question information for a plurality of evaluation targets. The server stores the past performance information in a structured data schema, such as a table with columns including a user identifier, an evaluation target identifier, a question identifier, a score value, a pass-fail flag, an answer time, and a timestamp. The server stores the past question information in a table with columns including a question identifier, an evaluation target identifier, a question text, one or more answer option texts, a correct answer value, a topic label, a difficulty level, and a question type.

The server executes a data analysis module that uses a data analysis library such as a tabular-data manipulation library to load rows from the database into in-memory data frames.

The server uses numerical computation routines to convert types, standardize value ranges, and compute derived quantities such as normalized scores, per-topic averages, and difficulty statistics.

The server executes a machine learning module that uses a machine learning library such as a general-purpose machine learning toolkit to train prediction models on the past performance information and the past question information. In one embodiment, the server uses a gradient-boosted decision tree model or a logistic regression model to predict a pass-fail indicator from question feature information. The server represents question feature information as a feature vector including, for example, a one-hot encoding of a topic label, an integer difficulty level, a categorical question type, and numerical statistics such as average historical score and time-to-answer. The server trains the prediction model by minimizing a loss function, such as a cross-entropy loss, with respect to model parameters by using an optimization method such as gradient descent or a boosted ensemble update. The server thereby obtains model parameters that approximate the conditional probability of a pass outcome given the question feature information.

The server uses the trained prediction model to compute, for each question, importance information and relevance information. The server computes the importance information, for example, as a predicted change in pass probability if the question is mastered, or as a feature importance score derived from the prediction model. The server computes the relevance information, for example, as a similarity between the question's feature vector and a target profile vector representing the evaluation target, using a distance metric such as cosine similarity. The server stores the importance information and the relevance information in an additional table or in additional columns of the question table.

The server executes a trend analysis module that computes trend information for each evaluation target. The server uses the data analysis library to group past question information by topic label and by year and to compute counts and average difficulty values. The server further uses a clustering algorithm, such as a K-means algorithm, on the question feature information to identify clusters of questions that tend to appear together in successful outcomes. The server records, for each cluster, statistics such as a frequency of appearance in past years and an average importance score. The server thereby derives trend information that characterizes which topics and question types are most predictive of success for the evaluation target.

The server executes a success-criterion extraction module that uses the importance information, the relevance information, and the trend information to determine success-criterion question information. In one embodiment, the server selects, for each topic, a subset of questions whose importance information is above a threshold and whose relevance information is above a threshold, and labels those questions as success-criterion questions. The server may also use a ranking algorithm to select the top-K questions per topic based on a composite score computed as a weighted sum of importance information and relevance information. The server stores identifiers and metadata of these success-criterion questions in a dedicated table.

The server executes a learning plan generation module. The server generates learning plan information for a user by combining the success-criterion question information, the trend information, and a profile of the user. The server stores the user profile as a record containing attributes such as evaluation targets selected by the user, past scores, estimated proficiency per topic, and time availability. The server computes a learning period, for example, by dividing the remaining time until an examination date into daily or weekly intervals. The server determines a learning order by sorting topics according to a difficulty progression and an estimated proficiency gap. The server determines a learning difficulty progression by starting from questions with lower difficulty levels and gradually increasing the difficulty based on thresholds derived from understanding information feedback. The server determines a learning amount, for example, as a number of questions per day that keeps a target total time under a specified limit by estimating per-question time from past performance information. The server stores the learning plan information as a structured object that references evaluation target identifiers, topic identifiers, time intervals, question identifiers, and difficulty levels.

The server executes a generative AI integration module that constructs prompt sentences for a generative AI model based on context information. The server maintains the context information for each user as a data structure including trend information, success-criterion question information, learning plan information, understanding information, and emotional state information. The server serializes subsets of this context information to concise textual summaries or structured text strings to be embedded into prompt sentences.

The server generates prompt sentences in natural language. In one example, the server generates a prompt sentence as follows:

“Based on the following exam trends and critical questions, create a detailed 2-week study plan for the selected exam. The plan should include daily topics, difficulty progression, and approximate number of problems per day. Trends: [summary of trend information]. Critical questions: [summary of success-criterion question information]. User proficiency: [summary of understanding information].”

In another example, the server generates a prompt sentence for question generation as follows:

“Generate one calculus question suitable for a high-school entrance examination, focusing on the chain rule. Provide a step-by-step model solution and a concise explanation that highlights common pitfalls.”

In yet another example, the server generates a prompt sentence for feedback as follows:

“The student answered the following question incorrectly and seems confused. Question: [question text]. Model answer: [reference answer]. Student answer: [user answer]. Explain the correct solution step by step and give two simple tips to avoid this error next time.”

The server sends the prompt sentence to the generative AI model through a network interface.

In one embodiment, the generative AI model is a large language model implemented as a transformer-based neural network with multiple attention layers, feed-forward layers, and layer normalization, trained on a large corpus of text data by minimizing a next-token prediction loss using gradient-based optimization. The server transmits the prompt sentence to the generative AI model through an application programming interface over a communication protocol such as HTTPS. The server receives generated outputs, such as learning plan supplement information, question generation information, answer generation information, or feedback text information, and parses the outputs into internal data structures.

The server executes an integration module that merges the outputs from the generative AI model with the learning plan information and the understanding information. The server validates the generated question texts by checking whether they satisfy structural constraints, such as containing a definable answer, and by optionally running a consistency check that compares generated model answers with numerical evaluations. The server attaches generated questions to specific positions in the learning plan based on topic and difficulty, and the server appends feedback text information to explanation fields associated with specific questions.

The terminal executes an application, for example implemented using a multi-platform user interface framework, that communicates with the server via a network protocol. The terminal presents the information presentation interface generated by the server, including menus of evaluation targets, views of learning plans, and question-and-answer screens. The terminal receives learning question information and reference answer information and displays question texts, answer options, and input fields on the display device.

The user operates the terminal by selecting evaluation targets, answering questions, and reading feedback. The terminal captures user answer information as text, numerical inputs, or selection events and transmits the user answer information to the server. The terminal further uses the camera to capture image information of the user's face during interaction, and uses the microphone to capture audio information of the user's voice, subject to user permission.

The terminal locally executes an emotion estimation module or transmits the captured image information and audio information to the server for processing. In one embodiment, the terminal executes a convolutional neural network trained for facial expression recognition.

This network includes multiple convolutional layers, pooling layers, and fully connected layers that output a vector of probabilities over emotion categories such as “happy,” “confused,” “frustrated,” “bored,” and “confident.” The terminal normalizes input images, detects facial landmarks, and feeds cropped face images into the network. In another embodiment, the terminal executes a recurrent neural network or a transformer network for audio-based emotion recognition, using spectral features such as Mel-frequency cepstral coefficients as input. The terminal transmits the resulting emotional state information, including emotion labels and confidence scores, to the server.

The server receives the emotional state information and the understanding information and updates a learning history record for the user. The server executes an adaptive control module that uses a rule set and, optionally, reinforcement learning to decide how to modify learning question information and learning plan information. The server applies non-conventional adaptation rules that combine emotion and performance. For example, the server may reduce difficulty when the user has a series of incorrect answers and a high probability of “frustrated,” but may increase difficulty when the user has consistently correct answers and a high probability of “confident.” The server implements these rules as operations on the learning plan information data structure, such as shifting some questions to later dates, replacing questions with lower or higher difficulty questions, or inserting review sessions.

The server modifies the prompt sentences for the generative AI model based on the learning history information. For example, when the user repeatedly struggles with a topic and shows “confused” emotional states, the server generates a prompt sentence:

“The student has repeatedly failed problems on the chain rule and appears confused. Generate an easier example problem on the chain rule, with a very detailed step-by-step explanation and a short motivational message suitable for a beginner.”

The server thereby obtains content that is customized both in difficulty and in tone. Because the server constructs the prompt sentences dynamically in response to numerical user state data, the interaction with the generative AI model is tightly coupled to the internal state of the system, rather than being a generic question-answering interface.

The server and the terminal jointly realize technical improvements in computer operation.

The server reduces data retrieval and computation overhead by storing precomputed importance information and relevance information and by structuring data in indexed tables.

The machine learning models allow the server to prioritize a small subset of high-impact questions rather than scanning entire question banks for every adaptation decision, thereby reducing computation time and improving scalability. The prediction model that links question feature information to pass-fail indicators enables the server to compute importance information in a single forward pass of the model, instead of resorting to exhaustive simulation, which improves computational efficiency.

The server improves the precision of personalization by systematically using emotional state information and understanding information in combination. The emotion estimation and adaptive control modules reduce the number of unproductive questions by detecting when the user is overwhelmed or bored and adjusting difficulty accordingly. This reduction in unproductive interactions results in fewer server-terminal communication cycles and less data transfer, which lowers communication load. The use of structured learning plan information and context-aware prompt sentences also improves data management, because the server maintains a consistent representation of user state that can be reused across sessions without recomputing from raw logs.

The generative AI model, when orchestrated by the server, processes prompt sentences that encode structured context and adaptation goals. This is different from a human tutor simply typing instructions to a general-purpose language model. The server enforces constraints on generated content, validates outputs, and integrates them into normalized internal data structures. The server's generation of prompt sentences and evaluation of outputs constitute a non-conventional use of a generative AI model as a programmable component in a data processing pipeline, which improves the system's ability to generate consistent and relevant content and reduces the risk of off-topic or invalid outputs.

The machine learning modules, including the prediction model and the emotion estimation models, are trained using supervised learning with labeled training data. The server or terminal uses a loss function, such as cross-entropy for classification or mean squared error for regression, and updates model weights by an optimization algorithm such as stochastic gradient descent or an adaptive gradient method. The server may perform data augmentation, such as random cropping and flipping for images, or random noise addition for audio, to improve robustness against variations in user appearance or environment. These techniques improve the accuracy and stability of emotion estimation under real-world conditions, which directly enhances the effectiveness of adaptive control.

The system architecture supports multiple embodiments and alternative configurations. In one embodiment, the server performs emotion estimation centrally, receiving raw or preprocessed sensor data from the terminal. In another embodiment, the terminal performs all emotion estimation locally and sends only emotion labels and confidence scores to the server, which reduces network bandwidth usage and preserves privacy. In a further embodiment, the prediction model for importance information is replaced by a neural network model with multiple hidden layers, which can capture non-linear interactions among question features and may yield higher prediction accuracy.

The server may also use different generative AI models for different purposes. For example, the server may use a smaller, low-latency generative model for real-time feedback text information, and a larger, more capable model for batch generation of learning plan supplement information. The server may cache generated content and reuse it when context information is similar, thereby further reducing computation and communication.

By combining structured data schemas, specific machine learning and deep learning algorithms, explicit feature representations, dynamically generated prompt sentences, and emotion-aware adaptive control mechanisms, the server and the terminal implement a concrete improvement in computer-implemented learning support. The system improves processing speed by prioritizing critical computations, improves accuracy by using trained models and emotion signals, and improves data management by maintaining consistent internal representations and context. The server and the terminal thereby provide a technical solution that goes beyond mere automation of human tutoring and instead enhances the operation of the computing system itself.

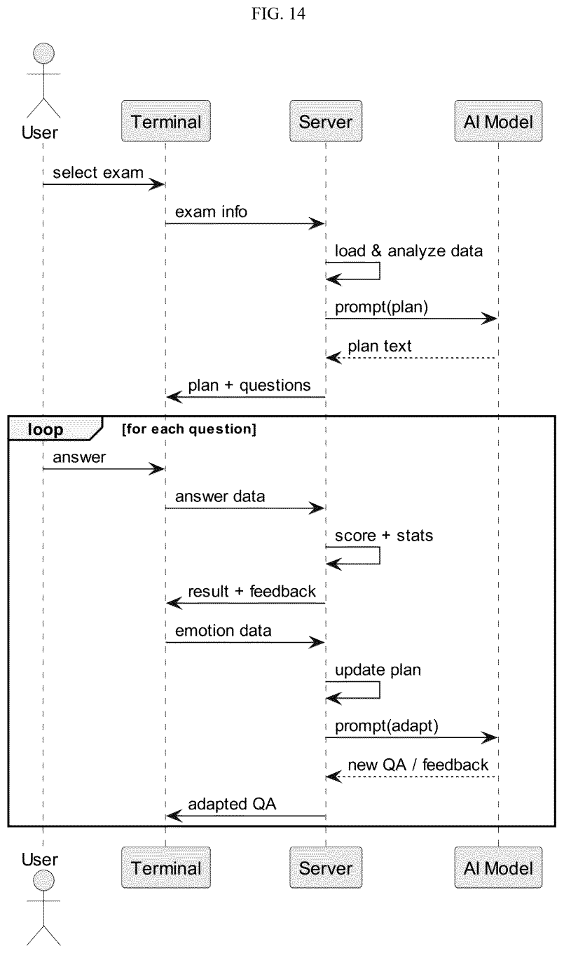

The following describes the processing flow using FIG. 14.

### Step 1:

User operates the terminal to select an evaluation target (for example, “university entrance mathematics”) from a graphical menu.

Input: A list of evaluation targets displayed by the terminal.

Output: Selected evaluation target identifier and user identifier sent to the server.

Terminal receives the user's selection event, associates it with a user identifier stored in local memory, and constructs a request message containing the evaluation target identifier.

Terminal sends this message to the server via a network interface using a protocol such as HTTPS.

### Step 2:

Server receives the selected evaluation target identifier and retrieves related past performance information and past question information from an information storage device.

Input: Evaluation target identifier, user identifier.

Output: Raw past performance records and raw past question records loaded into in-memory data structures.

Server executes database queries against relational tables, filtering rows where the evaluation target column matches the received identifier. Server loads the result sets into data frames, each row representing one historical attempt or one question, and caches these data frames in memory for further processing.

### Step 3:

Server preprocesses the past performance information and the past question information using statistical processing methods.

Input: Raw past performance data frame, raw past question data frame.

Output: Cleaned and normalized data frames with derived statistics.

Server removes rows with missing critical fields, converts text encodings to a unified format, and standardizes numerical fields (for example, scaling scores to a 0-1 range). Server computes aggregate statistics such as average score per topic, standard deviation of scores per difficulty level, and average answer time per question. Server appends these statistics as new columns to the data frames.

### Step 4:

Server constructs question feature information and trains or updates a prediction model using a machine learning method.

Input: Preprocessed performance data frame, preprocessed question data frame.

Output: Trained prediction model that maps question feature vectors to pass-fail indicator probabilities.

Server creates a feature matrix where each row corresponds to a question and each column corresponds to a feature, such as one-hot encoded topic labels, integer difficulty levels, historical average scores, and typical answer times. Server creates a label vector from pass-fail indicators aggregated over attempts on each question. Server fits a machine learning algorithm, such as logistic regression or a gradient-boosted tree model, by iteratively adjusting model parameters to minimize a loss function (for example, cross-entropy) using an optimization routine. Server stores the trained model parameters in memory or in persistent storage.

### Step 5:

Server computes importance information and relevance information for each question using the trained prediction model and other metrics.

Input: Trained prediction model, question feature matrix, trend statistics.

Output: Importance score and relevance score for each question, stored as additional attributes.

Server applies the prediction model to each question feature vector to estimate a probability of contributing to a pass outcome. Server derives importance information from these probabilities or from model-specific feature importance measures. Server computes relevance information by comparing each question's feature vector to a target profile vector for the evaluation target using a similarity metric. Server writes the resulting scores back into the question data frame and, optionally, into the database.

### Step 6:

Server extracts success-criterion question information based on importance information and relevance information.

Input: Question data frame with importance scores and relevance scores.

Output: Subset of questions flagged as success-criterion questions.

Server applies thresholding and ranking operations: for each topic, server filters questions whose importance score and relevance score exceed predetermined thresholds, then sorts the filtered questions by a composite score (such as a weighted sum of importance and relevance). Server selects a fixed number of top questions per topic and records their identifiers and metadata in a success-criterion question list.

### Step 7:

Server generates learning plan information for the user based on success-criterion question information, trend information, and user profile.

Input: Success-criterion question list, trend information, user profile (past scores, time until exam, available study time).

Output: Structured learning plan specifying periods, topic order, difficulty progression, and number of questions per period.

Server divides the available calendar time into discrete sessions (for example, days or weeks) and assigns topics to sessions according to topic difficulty and the user's current proficiency.

Server allocates success-criterion questions to sessions, starting with lower difficulty questions and gradually scheduling higher difficulty questions. Server estimates study load per session by summing expected answer times and adjusts allocation to keep each session under a preset time limit. Server stores the resulting learning plan as a record that references evaluation target identifiers, topic identifiers, time slots, and question identifiers.

### Step 8:

Server constructs a context representation and generates a prompt sentence for a generative AI model to refine the learning plan or generate additional content.

Input: Trend information, success-criterion question information, learning plan information, and optionally understanding information and emotional state information (if available).

Output: Prompt sentence text sent to the generative AI model and a corresponding context map stored on the server.

Server compresses large data structures into concise textual summaries, such as “Topic A is frequently failed and appears in 60% of exams,” and “User is weak on Topic B and has 3 weeks until exam.” Server embeds these summaries into a natural-language instruction.

Server, for example, generates a prompt sentence:

“Based on the following exam trends and critical questions, create a detailed 2-week study plan for the selected exam. The plan should include daily topics, difficulty progression, and approximate number of problems per day. Trends: [summary]. Critical questions: [summary].

User proficiency: [summary].”

Server logs the mapping between internal context objects and the prompt sentence for later interpretation of the generative AI model output.

### Step 9:

Server transmits the prompt sentence to the generative AI model and receives generated learning plan supplement information, question generation information, answer generation information, or feedback text information.

Input: Prompt sentence, possibly with embedded context text.

Output: Generated text output from the generative AI model, parsed into structured components.

Server sends the prompt sentence through a network API endpoint of the generative AI model. Server receives a text response and parses it to identify structured sections, such as day-by-day schedule entries, new question texts, model answers, or feedback paragraphs.

Server converts these sections into internal data structures and associates them with existing learning plan elements using identifiers or topic labels.

### Step 10:

Server integrates the generated information with the existing learning plan information and prepares data for presentation.

Input: Original learning plan information, generated supplement information, generated questions and answers, generated feedback text.

Output: Updated learning plan information and content bundle to be transmitted to the terminal.

Server merges generated schedule details into the learning plan by filling in unspecified fields (for example, recommended break days or review sessions). Server attaches newly generated questions to corresponding time slots and topics and stores model answers as reference answer information. Server associates generated feedback text with particular topics or difficulties. Server packages the merged plan and content into a response object that includes lists of sessions, questions, and explanatory texts.

### Step 11:

Server transmits the learning plan information, learning question information, and reference answer information to the terminal.

Input: Updated learning plan and content bundle.

Output: Response message containing plan and question data delivered to the terminal.

Server serializes the learning plan and question sets into a format suitable for transmission, assigns version numbers or timestamps, and sends the data to the terminal via the network interface. Server may compress the payload to reduce communication size and maintain a cache of transmitted items for quick reuse.

### Step 12:

Terminal receives the learning plan and questions, renders them, and collects user answers.

Input: Learning plan information, question texts, answer options, model answers (not shown to user initially).

Output: User answer information and interaction metadata sent to the server.

Terminal parses the received data, populates internal models for calendar views and question screens, and draws these views on the display. User selects a question, reads the text, and inputs an answer via touch or keyboard. Terminal performs basic checks (such as required field validation) and records timestamps and interaction patterns such as time spent per question. Terminal sends the user answer information, question identifier, and timing data to the server.

### Step 13:

Server compares user answer information with reference answer information and calculates understanding information.

Input: User answer information, reference answer information, question metadata.

Output: Per-question correctness results, scores, and aggregated understanding information per topic and difficulty.

Server executes comparison logic appropriate to the question type: direct equality checks for multiple choice, tolerance-based numerical comparisons for numeric responses, and string similarity or semantic scoring for text answers. For complex free-text answers, server optionally generates a specific prompt sentence for the generative AI model, such as: “You are grading an exam answer. Question: [question text]. Model answer: [reference answer]. Student answer: [user answer]. Score from 0 to 100 and briefly explain strengths and weaknesses.”

Server receives the model's scoring and explanation, parses the numeric score and commentary, and combines these with deterministic checks. Server aggregates per-question results into per-topic understanding scores by averaging or weighting based on importance information.

### Step 14:

Terminal or server estimates emotional state information from sensor data and sends or stores the result.

Input: Image information and audio information captured while the user interacts with questions and feedback.

Output: Emotional state information including emotion label and confidence value.

Terminal captures face images and voice segments during user interaction. Terminal or server normalizes and resizes the images, extracts features through a trained convolutional neural network, and outputs emotion probabilities for categories such as “confused” and “confident.” Terminal or server selects the maximum-probability label and its probability as the emotional state information. Terminal sends the emotional state information, along with timestamps and question identifiers, to the server, or server derives it directly if the processing is centralized.

### Step 15:

Server updates the user's learning history information and decides adaptation actions for future learning question information and learning plan information.

Input: Understanding information per topic and question, emotional state information, existing learning plan information.

Output: Adapted learning plan information and updated selection of learning question information.

Server inserts the new understanding and emotion records into a learning history table indexed by user and time. Server executes adaptation rules: for example, if understanding is low and emotion is “confused,” server selects easier questions for the next session; if understanding is high and emotion is “confident,” server schedules harder questions or new topics. Server modifies the learning plan data structure accordingly by reassigning question identifiers, changing difficulty levels, or inserting review blocks.

### Step 16:

Server generates updated prompt sentences for the generative AI model that reflect the new learning history information and adaptation decisions.

Input: Updated learning history information, adapted plan structure, recent performance trends.

Output: Revised prompt sentences for generating new questions, answers, or feedback.

Server composes a summary of the user's current weaknesses, strengths, and emotional patterns. Server embeds these summaries into prompt sentences such as:

“The student has difficulty with Topic X and often appears frustrated. Generate two easier practice questions on Topic X with very explicit hints and a short encouraging message.” or

“The student has mastered Topic Y and feels confident. Generate one more advanced question on Topic Y and a concise model solution that emphasizes deeper reasoning.”

Server sends these prompt sentences to the generative AI model to obtain new content aligned with the adapted plan.

### Step 17:

Terminal receives and presents feedback text information and adapted questions to the user, closing the loop.

Input: Updated questions, explanations, and feedback text information from the server.

Output: Displayed feedback and new interactive questions for subsequent user sessions.

Terminal updates its local representation of the learning plan, replaces or augments the current question list with adapted questions, and displays feedback text explaining recent performance and next steps. User reads the feedback, understands which areas improved or require more work, and proceeds to answer newly presented questions, thereby starting a new iteration of the processing flow.

The data generation model 58 is a so-called generative artificial intelligence (AI).

Examples of the data generation model 58 include generative Als such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

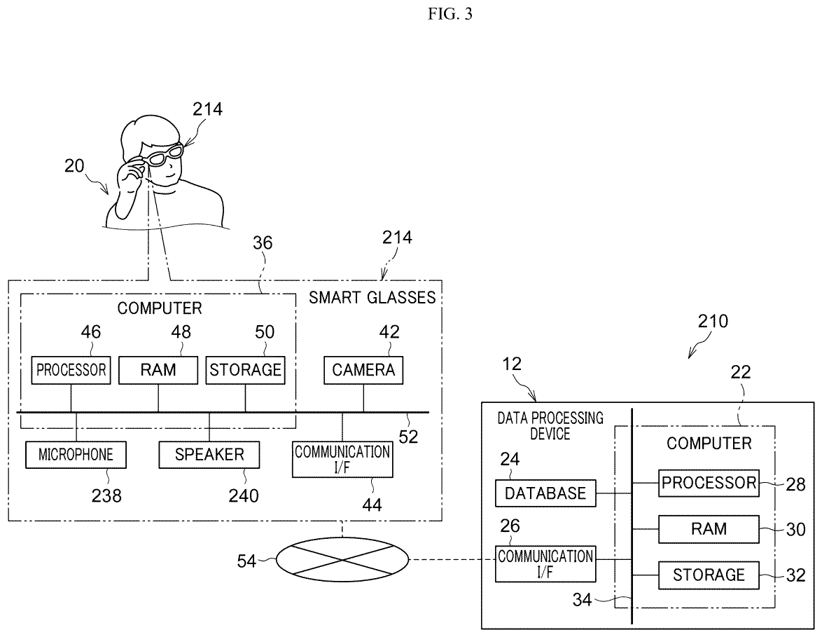

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

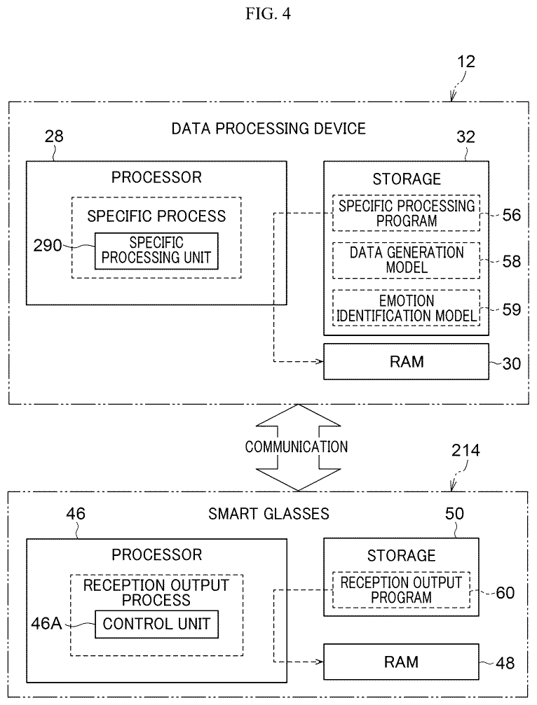

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

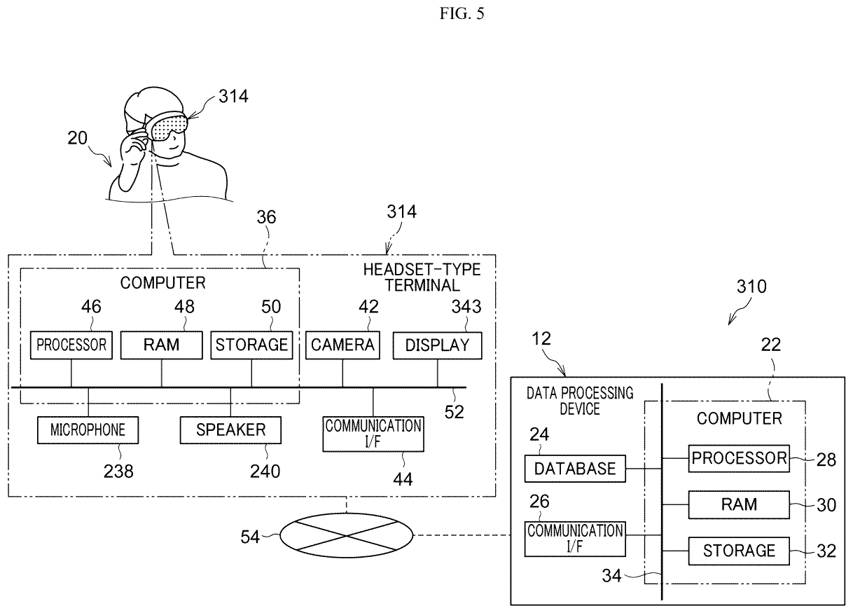

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

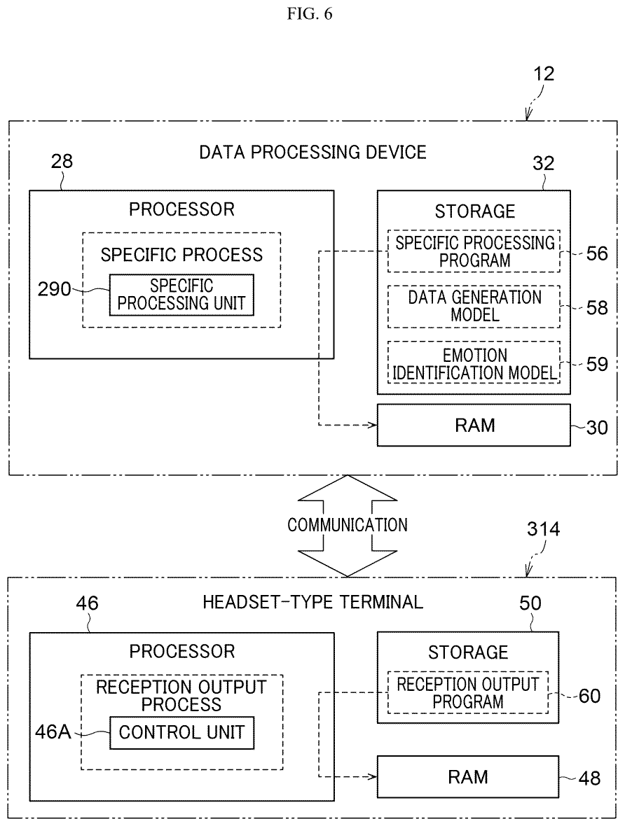

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

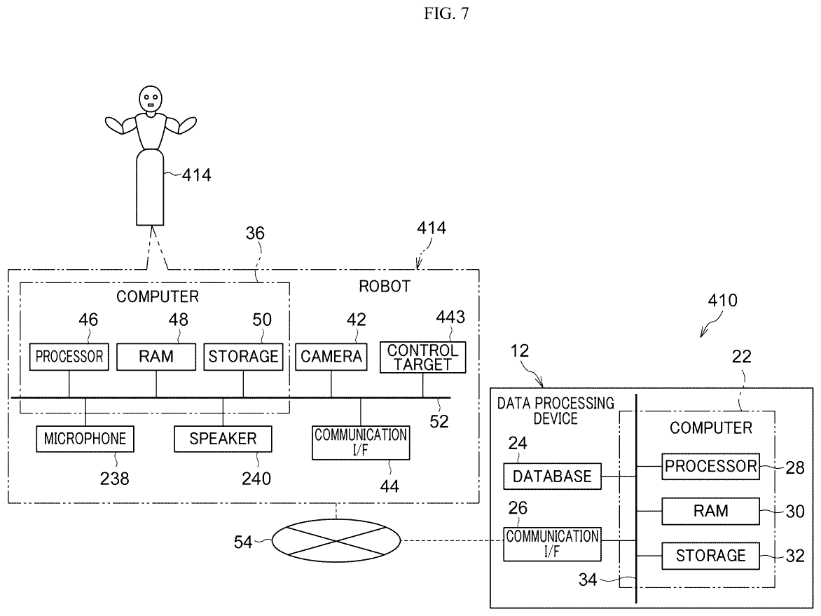

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

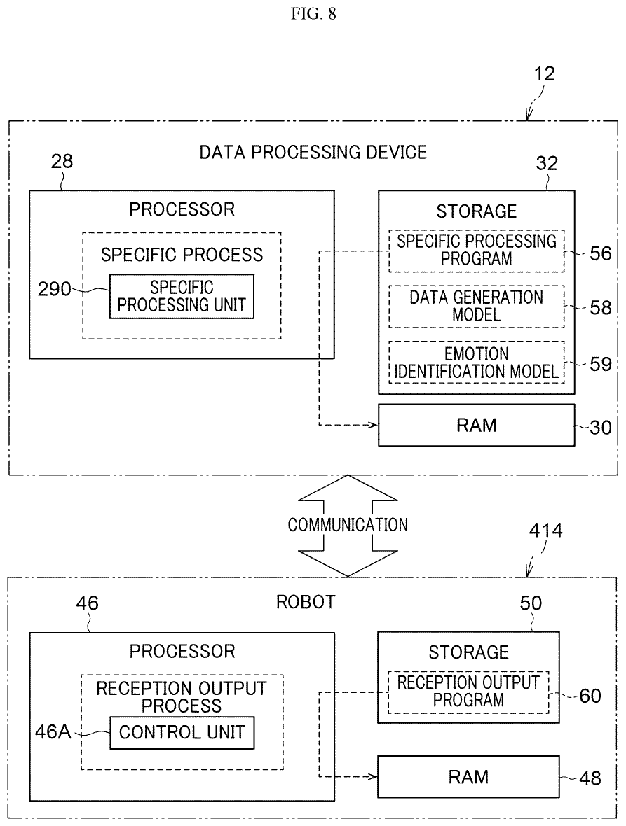

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

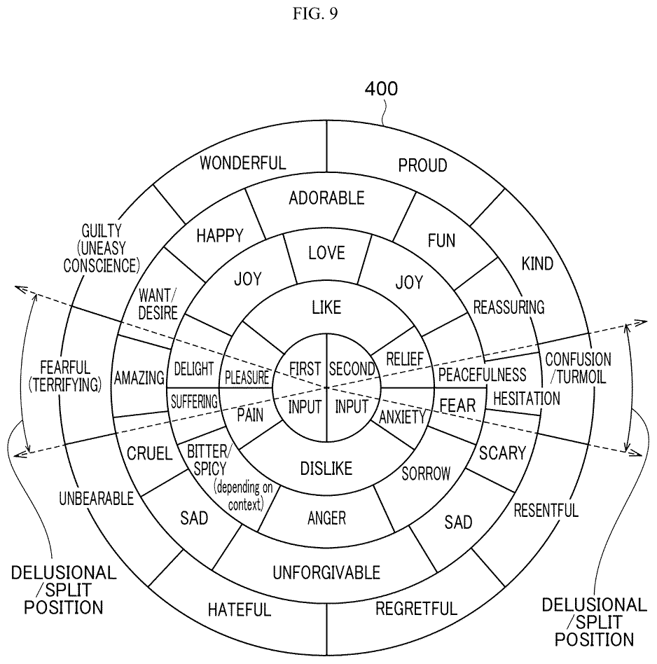

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

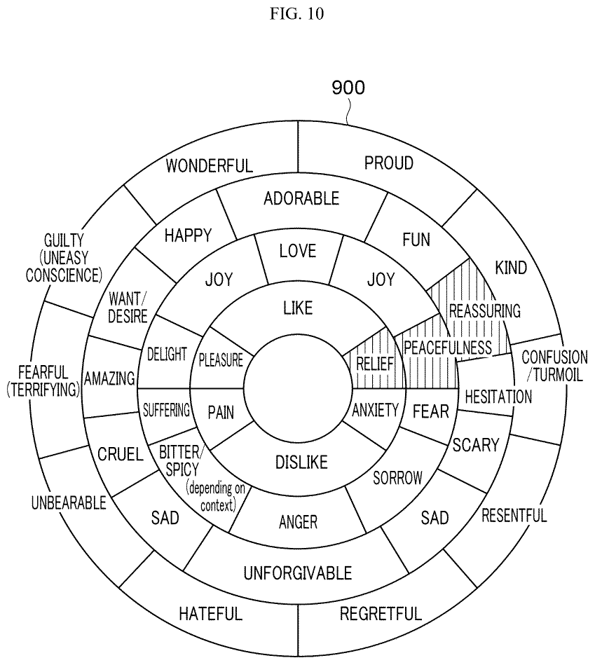

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
provide, to a user via an information processing terminal, an information display and input interface through which the user selects an evaluation target,
obtain, from a relational data management device by using a query language, past performance information and past question information associated with the selected evaluation target,
store the obtained performance information and question information as tabular data by using a numerical processing program executed on a general-purpose computation device, and apply statistical methods and learning algorithms to the tabular data so as to extract tasks contributing to a success criterion and a set of questions having high importance, and obtain, from a knowledge storage device, model answer information and explanation information corresponding to the set of questions,
generate structured data including the set of questions, the model answer information, and related statistical indicators, and generate a prompt sentence based on the structured data, input the prompt sentence and the structured data into a generative artificial intelligence model, cause the generative artificial intelligence model to output response data including explanation information and learning recommendation information for each question, and
integrate the obtained response data with the structured data as learning support data, convert the learning support data into a standardized description format or a standardized display format, transmit the converted data to the information processing terminal, and cause the information processing terminal to display tasks to be preferentially learned to satisfy the success criterion, the model answer information, and the explanation information generated by the generative artificial intelligence model, and
accumulate, in a recording device, operation history information and learning status information of the user, and dynamically adjust parameters of the statistical methods and the learning algorithms based on the accumulated information.

### (Supplementary 2)

The system according to supplementary 1,
wherein the processor is configured to
change the statistical methods and the learning algorithms in accordance with a type of the evaluation target and contents of the obtained performance information and question information, automatically extract a set of questions and topic categories characteristic of examinees near the success criterion, and dynamically determine a data structure and emphasized items in the prompt sentence based on an extraction result.

### (Supplementary 3)

The system according to supplementary 1,
wherein the processor is configured to
analyze the operation history information and the learning status information of the user, identify a set of questions, explanation information, and learning recommendation information that the user has intensively viewed, and reflect an identification result in conditions for generating the prompt sentence input to the generative artificial intelligence model, thereby performing optimized question selection, model answer presentation, and explanation generation for each user.

### Application Example 1

### (Supplementary 1)

A system comprising a processor,
wherein the processor is configured to
send presentation information to a terminal device to allow a user to select an evaluation target and related evaluation conditions, and receive, from the terminal device, identification information of the evaluation target and evaluation condition information, and
search and retrieve, from a structured information storage area stored in a storage device, past evaluation result information and past question information based on the identification information of the evaluation target and the evaluation condition information, combine the past evaluation result information and the past question information by using an information processing program, and calculate statistical information including at least occurrence frequency, correct answer rate, score contribution, and correlation with pass or fail so as to extract questions that contribute to a pass standard based on the statistical information, and acquire model answer information corresponding to the extracted questions from the structured information storage area and format the questions and the model answer information into a learning information structure in which each question is associated with corresponding model answer information, and
generate a prompt sentence, which is to be input to a generative artificial intelligence model, by embedding attribute information including at least an evaluation target name, a question period, and a question field into a natural language template of an instruction sentence based on the identification information of the evaluation target and the evaluation condition information, and
send the generated prompt sentence to an input/output interface of the generative artificial intelligence model to instruct improvement of an expression of the prompt sentence, and receive, from the generative artificial intelligence model, an improved prompt sentence, and structure the extracted questions, the model answer information, and the improved prompt sentence as learning presentation information and transmit the learning presentation information to the terminal device via a communication unit, and
accumulate, in the structured information storage area, browsing history information and operation history information of the user received from the terminal device, and update extraction conditions and weighting coefficients used for extracting the questions that contribute to the pass standard based on the accumulated history information.

### (Supplementary 2)

The system according to supplementary 1,
wherein the processor is configured to
dynamically change natural language instruction content of the prompt sentence for the generative artificial intelligence model so as to request generation or explanation enhancement of question groups contributing to the pass standard and corresponding model answer information, based on the identification information of the evaluation target, the statistical information derived from the past evaluation result information, and the browsing history information of the user.

### (Supplementary 3)

The system according to supplementary 1,
wherein the processor is configured to
perform user behavior analysis processing on the browsing history information and the operation history information of the user received from the terminal device, and, based on an analysis result, automatically adjust at least one of a presentation order, presentation frequency, and difficulty-level composition of the extracted questions that contribute to the pass standard, and generate a prompt sentence that causes the generative artificial intelligence model to generate additional explanations and additional questions according to a proficiency level of the user.

### Example 2

### (Supplementary 1)

A system comprising a processor,
wherein the processor is configured to
provide, based on input from a user information processing apparatus that performs information display and information input for a user, an interface for allowing the user to select an evaluation target, and
acquire, from an information storage apparatus, past performance information and past task information corresponding to the selected evaluation target, and use numerical processing means and statistical processing means to extract indicator information representing success criteria and question trend information specific to the evaluation target, and
identify, based on the extracted indicator information representing the success criteria and the extracted question trend information, high-importance learning target areas and task types to be preferentially addressed, and
generate learning plan information by dividing a learning period into a plurality of learning units based on the identified learning target areas and task types, and based on learning time information and evaluation execution date information acquired from the user, and by
assigning, to each learning unit, at least a learning target area, a task type, a number of problems, and a difficulty level, and
generate learning content information to be presented to the user information processing apparatus by extracting, from the information storage apparatus, task information and model answer information corresponding to each of the learning units on the basis of the generated learning plan information, and by combining the extracted task information and model answer information, and
construct input data for a generative artificial intelligence model based on a prompt sentence including a free-form inquiry text acquired from the user information processing apparatus and context information including at least the indicator information, the question trend information, and the learning plan information relating to the selected evaluation target, and cause the generative artificial intelligence model to generate a response text using the constructed input data, and
convert the generated response text into a predetermined display format and output the converted response text to the user information processing apparatus as additional explanation information or additional task information corresponding to the inquiry text, and
record, in the information storage apparatus as history information, each prompt sentence from the user, each response text generated by the generative artificial intelligence model, and the selected evaluation target and learning target area associated with the prompt sentence and the response text, and
update, based on the recorded history information, conditions for identifying the high-importance learning target areas and task types, and thereby dynamically change learning plan information to be generated subsequently and context information to be input to the generative artificial intelligence model.

### (Supplementary 2)

The system according to supplementary 1,
wherein the processor is configured to
set, according to the selected evaluation target, a plurality of analysis conditions including at least a weighting condition, a target period condition, and a task format condition for the past performance information and the past task information acquired from the information storage apparatus, and change processing parameters of the numerical processing means and the statistical processing means based on the analysis conditions so as to dynamically adjust an extraction method of the indicator information representing the success criteria and the question trend information.

### (Supplementary 3)

The system according to supplementary 1,
wherein the processor is configured to
collect, based on the generated learning plan information, operation history information and correct-answer status information of the user for the task information presented in each learning unit, calculate a difficulty scale and an achievement scale for the user based on the operation history information and the correct-answer status information, and update the input data to the generative artificial intelligence model by including the calculated difficulty scale and achievement scale in the context information so that the generative artificial intelligence model generates the response text adapted to the user.

### Application Example 2

### (Supplementary 1)

A system comprising a processor,
wherein the processor is configured to
provide an information presentation interface that allows a user to select an evaluation target, acquire past performance information and past question information related to the selected evaluation target from an information storage device, and perform preprocessing on the past performance information and the past question information using a statistical processing method and a machine learning method to extract trend information and success-criterion question information,
generate learning plan information including a learning period, a learning order, a learning difficulty, and a learning amount based on the trend information and the success-criterion question information,
transmit learning question information and reference answer information to a user terminal based on the learning plan information, and compare user answer information acquired from the user terminal with the reference answer information to calculate understanding information,
estimate emotional state information by analyzing image information and audio information acquired from the user terminal using an emotion estimation method, and dynamically update at least one of the learning question information to be subsequently presented and the learning plan information according to the understanding information and the emotional state information,
generate and transmit a prompt sentence to a generative artificial intelligence model based on context information including at least one of the trend information, the success-criterion question information, the learning plan information, the understanding information, and the emotional state information, and obtain from the generative artificial intelligence model at least one of learning plan supplement information, question generation information, answer generation information, and feedback text information, and
integrate at least one of the learning plan supplement information, the question generation information, the answer generation information, and the feedback text information obtained from the generative artificial intelligence model with the learning plan information and a result of the calculation of the understanding information, and cause the integrated information to be presented to the user.

### (Supplementary 2)

The system according to supplementary 1,
wherein the processor is configured to construct, by using a machine learning algorithm, a prediction model representing a relationship between question feature information and pass-fail indicator information based on a type of the selected evaluation target and the past performance information, and to calculate importance information and relevance information for each question by using the prediction model, and to extract the success-criterion question information based on the importance information and the relevance information.

### (Supplementary 3)

The system according to supplementary 1,
wherein the processor is configured to dynamically modify content and structure of the prompt sentence to be input to the generative artificial intelligence model based on learning history information including the understanding information and the emotional state information, and to individualize, for each user, at least one of the learning plan supplement information, the question generation information, the answer generation information, and the feedback text information obtained from the generative artificial intelligence model.

What is claimed is:

1. A system comprising:
circuitry configured to:
receive, via a communication interface coupled to a packet-switched network, identification data from a terminal device, the identification data specifying an evaluation target selected by a user;
retrieve, from a data storage device using a query language, past performance records and past question records associated with the evaluation target;
apply statistical methods and learning algorithms to the past performance records and past question records to extract a set of high-importance questions and tasks contributing to a pass criterion, and retrieve model answer information and explanation information corresponding to the extracted questions;
generate structured data comprising the extracted questions, the model answer information, and statistical indicators, construct a prompt sentence based on the structured data, and execute inference processing using a generative neural network model with the prompt sentence as input to obtain response data comprising explanation information and learning recommendation information;
integrate the response data with the structured data as learning support data, convert the learning support data into a transmission format, and transmit the converted learning support data to the terminal device via the communication interface; and
accumulate operation history information and learning status information of the user, and dynamically adjust parameters of the statistical methods and the learning algorithms based on the accumulated history information.

2. The system according to claim 1, wherein the circuitry is configured to apply the statistical methods by computing at least one of occurrence frequency, correct answer rate, score contribution, and correlation with pass or fail for questions in the past question records.

3. The system according to claim 2, wherein the circuitry is configured to extract questions near a pass criterion boundary by identifying questions whose statistical indicators exceed a significance threshold.

4. The system according to claim 3, wherein the circuitry is configured to dynamically change the statistical methods and the learning algorithms in accordance with a type of the evaluation target and contents of the past performance records.

5. The system according to claim 4, wherein the circuitry is configured to automatically extract question sets and topic categories characteristic of examinees scoring near the pass criterion, and determine a data structure and emphasis weights in the prompt sentence based on an extraction result.

6. The system according to claim 1, wherein the circuitry is configured to generate the prompt sentence by embedding attribute information comprising at least one of an evaluation target name, a question period, and a question field into a natural language template based on the identification data.

7. The system according to claim 6, wherein the circuitry is configured to transmit the prompt sentence to the generative neural network model to obtain an improved prompt sentence, and use the improved prompt sentence for subsequent inference processing.

8. The system according to claim 1, wherein the circuitry is configured to structure the learning support data into a learning information structure in which each extracted question is associated with corresponding model answer information and explanation information generated by the generative neural network model.

9. The system according to claim 8, wherein the circuitry is configured to analyze the operation history information and the learning status information to identify questions and explanation information intensively viewed by the user, and reflect an identification result in conditions for generating a subsequent prompt sentence.

10. The system according to claim 9, wherein the circuitry is configured to update extraction conditions and weighting coefficients for question extraction based on the accumulated browsing history information and operation history information.

11. The system according to claim 1, wherein the circuitry is configured to estimate an affective state of the user from the operation history information and the learning status information using an affective recognition algorithm.

12. The system according to claim 11, wherein the circuitry is configured to generate positive reinforcement data based on the estimated affective state, and transmit the positive reinforcement data to the terminal device when the estimated affective state indicates reduced motivation or elevated stress.

13. The system according to claim 1, wherein the circuitry is configured to receive a natural language query from the user via the terminal device, and instruct the generative neural network model to generate a context-aware response to the natural language query based on the structured data.

14. The system according to claim 13, wherein the circuitry is configured to include, in the prompt sentence for the natural language query, the identified high-importance questions and statistical indicators relevant to the query context.

15. The system according to claim 1, wherein the circuitry is configured to store extracted questions, model answer information, and statistical indicators in a structured information storage area of a storage device, and update stored records based on dynamically adjusted algorithm parameters.

16. The system according to claim 15, wherein the circuitry is configured to compute updated weighting coefficients for question importance based on the learning status information, and re-rank the extracted question set by applying the updated weighting coefficients.

17. The system according to claim 1, wherein the circuitry is configured to present, to the terminal device, tasks to be preferentially learned to satisfy the pass criterion, together with associated model answer information and generative neural network model-generated explanation information.

18. A system comprising:
circuitry configured to:
receive, via a communication interface coupled to a packet-switched network, evaluation target identification data from a terminal device;
retrieve, from a data storage device using a query language, past performance records and past question records, and apply statistical methods to the past performance records to compute occurrence frequency, correct answer rate, and score contribution metrics for questions in the past question records;
extract a set of questions having high importance scores and tasks contributing to a pass criterion, and retrieve model answer information and explanation information for the extracted questions from a structured information storage area;
generate a prompt sentence by embedding attribute information and statistical indicators into a natural language template, and execute inference processing using a generative neural network model to obtain explanation data and learning recommendation data for the extracted questions;
integrate the explanation data and the learning recommendation data with the extracted questions and model answer information as learning support data, and transmit the learning support data to the terminal device via the communication interface; and
accumulate operation history information and learning status information of the user, update extraction conditions and weighting coefficients for question importance based on the accumulated history information, and dynamically adjust parameters of the statistical methods based on the updated conditions.

19. The system according to claim 18, wherein the circuitry is configured to estimate an affective state of the user from the operation history information, and adjust content and granularity of the learning recommendation data in accordance with the estimated affective state.

20. A method comprising:
receiving, via a communication interface coupled to a packet-switched network, identification data from a terminal device, the identification data specifying an evaluation target selected by a user;
retrieving, from a data storage device using a query language, past performance records and past question records associated with the evaluation target;
applying statistical methods and learning algorithms to the past performance records and past question records to extract a set of high-importance questions and tasks contributing to a pass criterion, and retrieving model answer information and explanation information corresponding to the extracted questions;
generating structured data comprising the extracted questions, the model answer information, and statistical indicators, constructing a prompt sentence based on the structured data, and executing inference processing using a generative neural network model with the prompt sentence as input to obtain response data comprising explanation information and learning recommendation information;
integrating the response data with the structured data as learning support data, converting the learning support data into a transmission format, and transmitting the converted learning support data to the terminal device via the communication interface; and
accumulating operation history information and learning status information of the user, and dynamically adjusting parameters of the statistical methods and the learning algorithms based on the accumulated history information.
